(19) United States
(12) Patent Application Publication
(10) Pub. No.: US 2010/0183964 A1
(43) Pub. Date: Jul. 22, 2010

(54) ELECTROSTATIC IMAGE DEVELOPING GREEN TONER, ELECTROSTATIC IMAGE DEVELOPER, ELECTROSTATIC IMAGE DEVELOPING TONER SET, ELECTROSTATIC IMAGE DEVELOPER SET AND IMAGE FORMING APPARATUS

(75) Inventors: Satoshi YOSHIDA, Kanagawa (JP); Kiyohiro YAMANAKA, Kanagawa (JP); Masanobu NINOMIYA, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., Tokyo (JP)

(21) Appl. No.: 12/550,019

(22) Filed: Aug. 28, 2009

(30) Foreign Application Priority Data
Jan. 22, 2009 (JP) 2009-011553

(51) Int. Cl. G03G 9/10; G03G 15/08; G03G 9/00

(52) U.S. Cl. 430/107.1; 399/252; 430/109.4

(57) ABSTRACT

An electrostatic image developing green toner includes: a binder resin; a coloring agent; and a release agent, and the electrostatic image developing green toner satisfying the following equations:

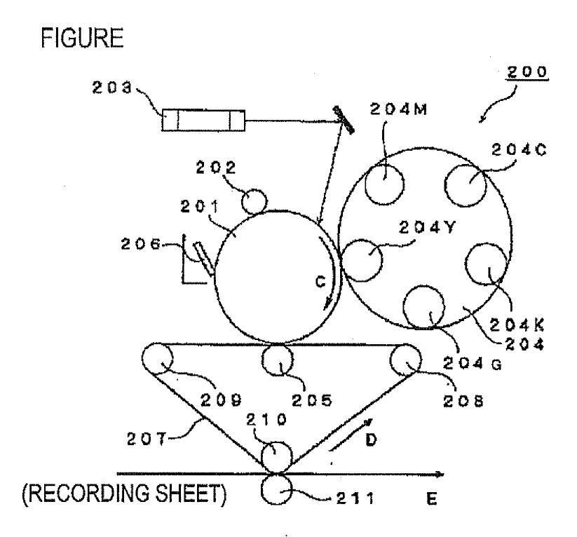

0.3<ID<1.2

160°<A<190°

wherein ID represents an image density at a time when a first image is formed by a loading amount of 4.0 g/m² of the green toner on a recording member; and A represents a hue angle of the first image represented by an L*a*b* color coordinate space, provided that an upside of a*+axis is taken as hue angle 0° and an upside of b*+axis is taken as hue angle 90°.

### CROSS-REFERENCE TO RELATED APPLICATION

This application is based on and claims priority under 35 USC 119 from Japanese Patent Application No. 2009-011553 filed Jan. 22, 2009.

### BACKGROUND

1. Technical Field

The present invention relates to an electrostatic image developing green toner, an electrostatic image developer, an electrostatic image developing toner set, an electrostatic image developer set, and an image forming apparatus.

2. Related Art

Methods of visualizing image data via electrostatic images such as electrophotography are now used in various fields. In electrophotography, image data are visualized through processes of, for example, forming an electrostatic latent image on an image holding member by charge and exposure process (a latent image-forming process), developing the electrostatic latent image with an electrostatic image developer (hereinafter sometimes referred to as merely “a developer”) containing an electrostatic image developing toner (hereinafter sometimes referred to as merely “a toner”) (a developing process), transferring the developed toner image to an intermediate transfer member by first transfer (a first transfer process), transferring the toner image transferred to the intermediate transfer member to a recording member by second transfer (a second transfer process), and a fixing process.

In electrophotography, when a full color image is formed, colors are generally reproduced by using four colors of three primary colors, i.e., combination of yellow, magenta and cyan, and a black toner. A secondary color, for example, a green image, is formed by lamination of a yellow toner and a cyan toner in a prescribed ratio.

### SUMMARY

According to an aspect of the invention, there is provided an electrostatic image developing green toner, including:

a binder resin;

a coloring agent; and

a release agent, and

the electrostatic image developing green toner satisfying the following equations:

0.3<ID<1.2

160°<A<190°

wherein ID represents an image density at a time when a first image is formed by a loading amount of 4.0 g/m² of the green toner on a recording member, and

A represents a hue angle of the first image represented by an L*a*b* color coordinate space, provided that an upside of a*+axis is taken as hue angle 0° and an upside of b*+axis is taken as hue angle 90°.

### BRIEF DESCRIPTION OF THE DRAWING

Exemplary embodiments of the present invention will be described in detail based on the following figures, wherein:

the drawing is a schematic drawing showing an example of the image-forming apparatus in the exemplary embodiment of the invention.

### DETAILED DESCRIPTION

The exemplary embodiment of the invention will be described below. The exemplary embodiment is an example for carrying out the invention, and the invention is not restricted thereto.

In the case of an image-forming method using an intermediate transfer member, at the time of first transfer from an image holding member to an intermediate transfer member, transfer is generally performed in order of yellow, magenta, cyan and black. Accordingly, at the time of second transfer from the intermediate transfer member to a recording member, toners are to be laminated on the recording member in order of black, cyan, magenta and yellow. In electrophotography, a green image is formed by lamination of a yellow toner and a cyan toner in a prescribed ratio, but if the ratio of the yellow toner and the cyan toner changes, the hue is to vary. For example, there is a case where the hue of the formed image changes according to the kind of recording member on which the image is formed.

For example, when the recording member is plain paper (general plain paper for copier, the surface of which is not treated such as coating), plain paper is hygroscopic, so that electric field of transfer is liable to leak at the time of transfer and transfer efficiency sometimes lowers. Further, the more the toner is in contact with the intermediate transfer member, the more it remains behind at the time of second transfer (liable to cause transfer failure). Since a yellow toner transferred earlier to the intermediate transfer member at first transfer time generally remains behind on the intermediate transfer member, the yellow toner is insufficient and sometimes the hue of a green image approaches cyan side.

Further, formation unevenness (unevenness and the like according to the paper fibers) is present on the surface of paper in the case of plain paper, so that there are cases where transfer efficiency varies in the concavities of a recording member such as plain paper, or change of the ratio of the yellow toner and the cyan toner occurs due to permeation of the toners into paper fibers. In general, in the image structure on a recording member, since the cyan toner in a layer lower than the yellow toner permeates into paper fibers, there are cases where the hue of a green image approaches yellow side. In an image low in the loading amounts of toners, hue variation due to permeation is liable to occur more conspicuously. That is, on plain paper, with an image high in the loading amounts of toners, the toner of the upper layer of image is insufficient by deterioration of transfer efficiency resulting from the variation of transfer efficiency. On the other hand, with an image low in the loading amounts of toners, the toner of the lower layer of image is insufficient by permeation at the time of fixation, and deviation of hue by image density is liable to be caused.

On the other hand, with a recording member such as coated paper having a coat layer on the surface of the paper, the variation of transfer efficiency and permeation of toner into paper fibers are difficult to occur and a change in hue is not liable to be generated as compared with plain paper. Therefore, deviation of hue easily occurs between papers such as coated paper and plain paper. Thus, it is desired to suppress both cyan coloring of hue by transfer failure and yellowing of hue by permeation at fixing time, and control changing in hue in accordance with the kind of recording member on which an image is formed.

Accordingly, for the compensation of hue, a green toner approaching cyan in hue and light in color (a light colored green toner) is used in combination in forming a green image. In particular, a green toner more approaching cyan in hue and lighter in color than the hue of a green image formed of yellow 100% and cyan 100% used together in image-forming apparatus is used in combination. For example, by forming an image so that a light colored green toner comes on the side of the intermediate transfer member at first transfer time, a change in the variation of the ratio of the yellow toner and the cyan toner is restrained even if a part of the light colored green toner remains on the intermediate transfer member at the time of second transfer. At fixing time, even if a part of the cyan toner in the lower layer permeates into the fibers of the recording member to cause yellowing of the hue of the image, the hue is compensated for by lamination of the light colored green toner approaching cyan in hue.

Yellowing of an image by penetration cannot be compensated for by the case of using the light colored toner having the same color as the green image formed of yellow toner 100% and cyan toner 100%. Further, when a deep colored green toner is used, not only a change in hue by penetration cannot be restrained but also deterioration of graininess cannot be controlled in the area low in a loading amount of toners.

When a crystalline resin is contained in a toner as the binder resin, and in particular, a crystalline resin is contained at least in a cyan toner as the binder resin, control of a change in hue is further improved. The reason for this fact is that since the crystalline resin necessitates heat of fusion of crystal in melting at the time of fixation of the toner, as compared with the case of using an amorphous resin having the same viscosity, the crystalline resin necessitates longer time of heating or higher quantity of heat for fusion. Therefore, as compared with the case where the binder resin of a toner is consisted of an amorphous resin alone, in particular, as compared with the case where the binder resin of a cyan toner, which is positioned on the side of the recording member in a green image, is consisted of an amorphous resin alone, the binder resin is difficult to melt and penetration into the recording member is restrained, as a result a change in hue of the image is controlled.

### <Electrostatic Image Developing Green Toner and Electrostatic Image Developing Toner Set>

The electrostatic image developing green toner according to the exemplary embodiment of the invention (hereinafter sometimes referred to as merely “green toner”) contains a binder resin, a coloring agent and a release agent, and satisfies the following equations taking the image density as ID at the time when an image is formed by the loading amount of 4.0 g/m² of the toner on a recording member, and the hue angle of the image represented by L*a*b* color coordinate space (provided that the upside of a*+axis is taken as hue angle 0° and the upside of b*+axis as hue angle 90°) as A:

0.3<ID<1.2

160°<A<190°

Further, it is preferred for the electrostatic image developing green toner according to the exemplary embodiment to satisfy the following equations taking the image density as IDcy at the time when an image is formed on a recording member by a cyan toner and a yellow toner in loading amount of 4.0 g/m² respectively used together in an image-forming apparatus, and the hue angle of the image represented by L*a*b* color coordinate space as Acy:

0.1<(ID/IDcy)<0.7

Acy<A

In the toner according to the exemplary embodiment, when an image is formed by the loading amount of 4.0 g/m² of a toner on a recording member, the image density ID is 0.3<ID<1.2, and preferably 0.4<ID<0.9. When ID is 0.3 or less, the density is too low and a change in hue of the green image cannot be controlled, while when ID is 1.2 or more, a change in hue of the green image of low image density cannot be controlled. Image density varies according to toner particle size and the amount of developing toner. That is to say, when a particle size of a toner becomes small, the packing density of the toner increases when an image is formed, so that a good image is obtained even if the amount of the developing toner is small. When an image is formed by the loading amount of 4.0 g/m² of a toner on a recording member in the exemplary embodiment, the image density means the image density of the image formed so that the density of the cyan coloring agent such as a cyan pigment or the like on the recording member becomes 0.2 g/m².

In the green toner according to the exemplary embodiment, when an image is formed by the loading amount of 4.0 g/m² of a toner on a recording member, the hue angle A of the image represented by L*a*b* color coordinate space (provided that the upside of a*+axis is taken as hue angle 0° and the upside of b*+axis as hue angle 90°) is 160°<A<190°, and preferably 170°<A<185°. When A is less than 160°, the hue of the green toner approaches the hue of the yellow toner and a change in hue of the green image is not controlled, while when A exceeds 190°, the hue of the green toner approaches the hue of the cyan toner and a change in hue of the green image is not controlled.

In the green toner according to the exemplary embodiment, when an image is formed on a recording member by the loading amount of 4.0 g/m² of a cyan toner and a yellow toner used together in an image-forming apparatus, the image density IDcy at the time is preferably 0.1<(ID/IDcy)<0.7, and more preferably 0.2<(ID/IDcy)<0.6. When (ID/IDcy) is 0.1 or less, the density is too low and there is a case where a change in hue of the green image is not controlled, while when (ID/IDcy) is 0.7 or more, there is a case where a change in hue in the green image of low image density is not controlled.

In the green toner according to the exemplary embodiment, when an image is formed on a recording member by the loading amount of 4.0 g/m² of a cyan toner and a yellow toner used together in an image-forming apparatus, the hue angle Acy of the image represented by L*a*b* color coordinate space is preferably Acy<A. When Acy is Acy≧A, there is a case where insufficiency of the cyan due to penetration cannot be compensated for. Further, Acy is preferably 5°<(A−Acy)<35°, and more preferably 10°<(A−Acy)<30°. When (A−Acy) is 5° or less, the hue of the green toner approaches the hue of the cyan toner, and there is a case where a change in hue of the green image is not controlled, while when (A−Acy) is 35° or more, the hue of the green toner approaches the hue of the yellow toner, and there is a case where a change in hue of the green image is not controlled.

The hue angle A of a green toner may be adjusted by the kinds of pigments and dyes used as the coloring agents of the toner and the dispersion sizes of pigments to be used. The hue angle A nay also be adjusted by the use of a plurality of kinds of pigments and dyes as the coloring agents.

Image density ID may be adjusted by the content of the coloring agent in a toner and the dispersion size of pigment to be used.

The electrostatic image developing toner set according to the exemplary embodiment (hereinafter sometimes referred to as merely “toner set”) contains at least a cyan toner containing a binder resin, a coloring agent and a release agent, a yellow toner containing a binder resin, a coloring agent and a release agent, and a green toner containing a binder resin, a coloring agent and a release agent. The electrostatic image developing toner set satisfies the following equations taking the image density as ID at the time when an image is formed by the loading amount of 4.0 g/m² of the green toner on a recording member; the hue angle of the image represented by L*a*b* color coordinate space (provided that the upside of a*+axis is taken as hue angle 0° and the upside of b*+axis as hue angle 90°) as A, taking the image density as IDcy at the time when an image is formed by the loading amount of 4.0 g/m² of the cyan toner and the yellow toner on a recording member, respectively, and the hue angle of the image represented by L*a*b* color coordinate space as Acy:

0.3<ID<1.2

160°<A<190°

0.1<(ID/IDcy)<0.7

Acy<A

The electrostatic image developing toner set according to the exemplary embodiment may further contain a magenta toner, a black toner, and the like.

### (Binder Resin)

As the binder resins of the toner, amorphous resins of monomers or copolymers thereof such as monoolefin, e.g., ethylene, propylene, butylenes, isoprene, etc.; vinyl ester, e.g., vinyl acetate, vinyl propionate, vinyl benzoate, vinyl butyrate, etc.; α-methylene aliphatic monocarboxylates, e.g., methyl acrylate, phenyl acrylate, octyl acrylate, methyl metharylate, ethyl methacrylate, butyl methacrylate, dodecyl methacrylate, etc.; vinyl ethers, e.g., vinyl methyl ether, vinyl ethyl ether, vinyl butyl ether, etc.; vinyl ketones, e.g., vinyl methyl ketone, vinyl hexyl ketone, vinyl isopropenyl ketone, etc.; are exemplified. Of these resins, representative binder resins include polystyrene, styrene-alkyl acrylate copolymer, styrene-butadiene copolymer, styrene-maleic anhydride copolymer, polystyrene, polypropylene, etc. In addition, polyester, polyurethane, epoxy resin, silicone resin, polyamide, modified rosin, etc., are further exemplified.

Further, as described above, it is preferred to contain crystalline resins having crystallizability as the binder resins, and crystalline resins and the above-described amorphous resins may be contained.

The content of the crystalline resin in the binder resin of the toner in the case of containing crystalline resin is, for example, preferably in the range of 2 wt % or more and 20 wt % or less or about 2 wt % or more and about 20 wt % or less, and more preferably in the range of 3 wt % or more and 10 wt % or less or about 3 wt % or more and about 10 wt % or less. When the content of the crystalline resin is less than 2 wt %, heat absorption by the crystalline resin is insufficient at the time of fixation, so that the effect of addition cannot be obtained sometines, while when the content exceeds 20 wt %, the domain of the crystalline resin in the toner is larger and also the number of domains increases, as a result there is a case where the transparency of a formed image is degraded. The content of a crystalline resin in a binder resin of toner is calculated by the following method.

In the first place, a toner is dissolved in methyl ethyl ketone (MEK) at ordinary temperature (from 20 to 25° C.). This is for the reason that when a crystalline polyester resin and an amorphous resin are contained in the toner, almost the amorphous resin alone is dissolved in MEK at ordinary temperature. Accordingly, in MEK-soluble content is contained the amorphous resin, and the amorphous resin is obtained from a supernatant separated by centrifugal separation or dissolution. On the other hand, by heating the solid content obtained after centrifugal separation at 65° C. for 60 minutes and dissolving in THF, and by filtering the dissolved product through a glass filter, the crystalline polyester resin is obtained from the filtered remainder. If temperature lowers during filtration by this operation, the crystalline resin is precipitated. Therefore, the operation is performed swiftly in the state of thermal insulation so that the temperature does not lower. The content of a crystalline resin can be found by the measurement of the amount of the thus-obtained crystalline polyester resin.

In the exemplary embodiment, “crystalline” of “crystalline resin” means to have a clear endothermic peak in temperature ascending stage and also have a clear exothermic peak in temperature descending stage, not a stepwise change in heat absorption amount, in differential scanning calorimetry (DSC) of a resin. Specifically, in differential scanning calorimetry (DSC) with a differential scanning calorimeter equipped with an automatic tangential treatment system (the name of instrument: DSC-60 type, manufactured by Shimadzu Corporation), when the temperature from the onset point to the peak top of endothermic peak is within 10° C. at the time of temperature ascending at a temperature ascending rate of 10° C./min, it is defined to be a “clear” endothermic peak. On the other hand, when the temperature from the onset point to the peak top of exothermic peak is within 10° C. at the time of temperature descending at a temperature descending rate of 10° C./min from 150° C. and a calorific value is 20 J/g or more, it is defined to be a “clear” exothermic peak. Further, from the viewpoint of sharp melting, the temperature from the onset point to the peak top of endothermic peak is preferably within 10° C., and more preferably within 6° C. By pointing an optional point of a flat part of the base line on a DSC curve and an optional point of a flat part of the rising part from the base line, and the intersectional point of the tangential lines of the flat part between both points is automatically found as the “onset point” by the automatic tangential treatment system. When the resin is made to a toner, there is a case where the endothermic peak shows a peak having a width of 40 to 50° C.

“Amorphous resins” used as the binder resin indicates the resins not coming under the above crystalline resin. Specifically, in differential scanning calorimetry (DSC) with a differential scanning calorimeter equipped with an automatic tangential treatment system (the name of instrument: DSC-60 type, manufactured by Shimzadzu Corporation), when the temperature from the onset point to the peak top of endothermic peak exceeds 10° C. at the time of temperature ascending at a temperature ascending rate of 10° C./min, or when a clear endothermic peak is not observed, or when a clear exothermic peak is not observed in temperature descending, it is defined to be “amorphous”. Further, it is preferred for the temperature from the onset point to the peak top of the endothermic peak to exceed 12° C., and it is more preferred not to have a clear endothermic peak. The method to find “onset point” on a DSC curve is the same as the case of the “crystalline resin”.

As the crystalline resins, specifically crystalline polyester resins, crystalline vinyl-based resins are exemplified, but crystalline polyester resins are preferred from the aspects of the adhesion to sheet at fixing time, a charging property and the adjustment of melting temperature in a preferred range. In addition, aliphatic crystalline polyester resins having a proper melting temperature are more preferred.

As the crystalline vinyl-based resins, vinyl resins using (meth)acrylates of long chain alkyl or alkenyl, e.g., amyl (meth)acrylate, hexyl (meth)acrylate, heptyl (meth)acrylate, octyl (meth)acrylate, nonyl (meth)acrylate, decyl (meth)acrylate, undecyl (meth)acrylate, tridecyl (meth)acrylate, myristyl (meth)acrylate, cetyl (meth)acrylate, stearyl (meth)acrylate, oleyl (meth)acrylate, behenyl (meth)acrylate, etc., are exemplified. Incidentally, in the specification of the invention, the description of “(meth)acrylate” means to include both “acryl” and “(meth)acryl”.

### (Crystalline Polyester Resin)

Crystalline polyester resin dispersion is made by dispersing a crystalline polyester resin in an aqueous medium. The crystalline polyester resins for use in crystalline polyester resin dispersion are described below.

The crystalline polyester resins are resins synthesized from a divalent acid (dicarboxylic acid) component and a divalent alcohol (diol) component, and “crystalline polyester resins” shows those having a clear endothermic peak not a stepwise change in heat absorption amount in differential scanning calorimetry (DSC). In the case of a polymer obtained by copolymerization of other component to the main chain of a crystalline polyester resin and other component accounts for 50 mass % or less, this copolymer is also designated as a crystalline polyester resin.

In the crystalline polyester resins, as the acids to become components derived from acids, various dicarboxylic acids are exemplified. The components derived from acids are not restricted to one kind and two or more kinds of components derived from dicarboxylic acids may be contained. For the purpose of bettering an emulsifying property in an emulsification aggregation method, there are cases where the dicarboxylic acids contain a sulfonic acid group.

The “components derived from acids” means the constituting portions that are acid components before synthesis of polyester resins, and “components derived from alcohols” described below indicates the constituting portions that are alcohol components before synthesis of polyester resins.

As the dicarboxylic acids, aliphatic dicarboxylic acids are preferred, and straight chain type dicarboxylic acids are especially preferred. As the straight chain type dicarboxylic acids, e.g., oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, 1,12-dodecanedicarboxylic acid, 1,13-tridecamedicarboxylic acid, 1,14-tetradecanedicarboxylic acid, 1,18-octadccanedicarboxylic acid, and 1,20-eicosanedicarboxylic acid, and lower alkyl esters and acid anhydrides thereof are exemplified. Dicarboxylic acids having 6 to 20 carbon atoms are preferred, above all. For increasing crystallizability, it is preferred to use these straight chain type dicarboxylic acids in proportion of 95 mol % or more of the acid component, and more preferably 98 mol % or more.

As the components derived from acids, besides the above components derived from aliphatic dicarboxylic acids, components such as components derived from derived from dicarboxylic acids having a sulfonic acid group may be contained. Further, in manufacturing toner particles by emulsification or suspension of resin at large in water, emulsification or suspension is possible by the presence of a sulfonic acid group without using a surfactant, as described later.

As the dicarboxylic acids having a sulfonic acid group, e.g., sodium 2-sulfoterephthalate, sodium 5sulfoisophthalate, sodium sulfosuccinate are exemplified, but the dicarboxylic acids having a sulfonic acid group are not restricted thereto. Lower alkyl esters and acid anhydrides of these dicarboxylic acids are also exemplified. Of these, sodium 5-sulfoisophthalate is preferred in the point of productivity. The content of the dicarboxylic acids having a sulfonic acid group is preferably 2.0 constituting mol % or less, and more preferably 1.0 constituting mol % or less. The above “constituting mol %” means percentage with each component in the polyester resin (a component derived from acid, a component derived from alcohol) being 1 unit.

As the alcohols to become components derived from alcohols, aliphatic dialcohols are preferred, e.g., ethylene glycol, 1,3-propanediol, 1,4-butanediol, 1,5-pentanediol, 1,6-hexazediol, 1,7-heptanediol, 1,8-octanediol, 1,9-nonanediol, 1,10-decanediol, 1,11-dodecanediol, 1,12-undecanediol, 1,13-tridecatediol, 1,14-tetradecanediol, 1,18-octadecanediol, and 1,2-eicosanediol are exemplified. Those having 6 to 20 carbon atoms are preferred above all. For heightening crystallizability, it is preferred to use these straight chain type dialcohol in proportion of 95 mol % or more of the alcohol components, and more preferably 98 mol % or more.

As other divalent dialcohols, e.g., bisphenol A, hydrogenated bisphenol A, ethylene oxide or (and) propylene oxide adduct of bisphenol A, 1,4-cyclohexanediol, 1,4-cyclohexanedimethanol, diethylene glycol, propylene glycol, dipropylene glycol, 1,3-butanediol, neopentyl glycol are exemplified. These dialcohols may be used by one kind alone, or two or more kinds may be used in combination.

Further, if necessary, for the purpose of the adjustment of an acid value and a hydroxyl group value, a monovalent acid, e.g., acetic acid, benzoic acid, etc., monovalent alcohols, e.g., cyclohexanol, benzyl alcohol, etc., benzenetricarboxylic acid, naphthalenetricarboxylic acid, etc., anhydrides thereof, lower alkyl esters thereof, and trivalent alcohols, e.g., glycerin, trimethylolethane, trimethylolpropane, pentaeyhritol, etc., may be used.

As other monomers, they are not especially limited and, for example, conventionally well-known divalent carboxylic acids and divalent alcohols are known, which are the monomer components described in Kobunshi Data Handbook, Kiso-Hen (Polymer Data Handbook, Fundamentals), compiled by The Society of Polymer Science, published by Baifu-kan. As the specific examples of these monomer components, as the divalent dicarboxylic acids, dibasic acids, e.g., phthalic acid, isophthalic acid, terephthalic acid, naphthalene-2,6-dicarboxylic acid, naphthalene-2,7-dicarboxylic acid, cyclohexanedicarboxylic acid, etc., and anhydrides and lower alkyl esters of these acids are exemplified. These monomers may be used alone, or two or more in combination.

The crystalline polyester resin may be synthesized by optional combinations of the above monomer components according to conventionally known methods described in, for example, Jushukugo (Polycondensation), Kagaku Dojin Publishing Company, Inc., Kobunshi Jikken-Gaku—Jushukugo to Jufuka (Polymer Experimental Science—Polycondensation and Polyaddition), Kyoritsu Shuppan Co., Ltd., and Polyester Jushi Handbook (Polyester Resin Handbook), compiled by Nikkan Kogyo Shinbun, and the ester exchange method and the direct polycondensation method may be used alone or in combination.

Specifically, polymerization may be performed at a polymerization temperature of 140 to 270° C., if necessary, under reduced pressure, and with removing water and alcohol occurring in condensation. When a monomer is not soluble or compatible under the reaction temperature, a solvent having a high boiling temperature may be added as a dissolution assisting solvent for dissolution. Polycondensation is preferably performed with removing the dissolution assisting solvent. When a hardly compatible monomer is present in copolymerization reaction, it is preferred that the hardly compatible monomer and the acid or alcohol prearranged to be polycondensed with that monomer are subjected to condensation in advance, and then polycondensed with the main component. The molar ratio of the acid component and alcohol component (acid component/alcohol component) for the reaction differs in accordance with the reaction condition and the like and cannot be said unconditionally, but in the case of direct polycondensation, the molar ratio is generally 0.9/1.0 or more and 1.0/0.9 or less. In the case of ester exchange reaction, there are cases where monomers capable of desulfurization in a vacuum such as ethylene glycol, propylene glycol, neopentyl glycol, cyclohexanedimethanol and the like are excessively used.

Catalysts usable in the manufacture of the crystalline polyester resin include titanium-containing catalysts, such as aliphatic titanium carboxylates, for example, aliphatic titanium monocarboxylate, e.g., titanium acetate, titanium propionate, titanium hexanoate, titanium octanoate, etc., aliphatic titanium dicarboxylate, e.g., titanium oxalate, titanium succinate, titanium maleate, titanium adipate, titanium sebacate, etc., aliphatic titanium tricarboxylate, e.g., titanium hexanetricarboxylate, titanium isooctanericarboxylate, etc., and aliphatic titanium polycarboxylate, e.g., titanium octanetetracarboxylate, titanium decanetetracarboxylate, etc.; aromatic titanium carboxylates, such as aromatic titanium monocarboxylate, e.g., titanium benzoate, etc., aromatic titanium dicarboxylate, e.g., titanium phthalate, titanium terephthalate, titanium isophthalate, titanium naphthalenedicarboxylate, titanium bipheuyldicarboxylate, titanium anthracenedicarboxylate, etc., aromatic titanium tricarboxylate, e.g., titanium trimellitate, titanium naphthalenetricarboxylate, etc., and aromatic titanium tetracarboxylate, e.g., titanium benzenetetracarboxylate, titanium naphthalenetetracarboxylate, etc.; titanyl compounds of aliphatic titanium carboxylates and aromatic titanium carboxylates, and alkali metal salts thereof; titanium halides, e.g., titanium dichloride, titanium trichloride, titanium tetrachloride, titanium tetrabromide, etc.; titanium tetralkoxides, e.g., titanium tetrabutoxide, titanium tetraoctoxide, titanium tetrastearyloxide, etc.; titanium acetyl acetonate, titanium diisopropoxide bisaectyl acetonate, titanium triethanol aminate, etc.

The titanium-containing catalysts and inorganic tin catalysts are mainly used as catalysts, but other catalysts may be used as mixture. As other catalysts, catalysts corresponding to the above amorphous polyester resins may be used.

It is preferred to use these catalysts in polymerization in the range of 0.02 mass parts or more and 1.0 mass part or less to 100 mass parts of the monomer component. However, when foregoing catalysts are used as mixture, the content of the titanium-containing catalysts is preferably 70 mass % or more, and it is more preferred that all the catalysts are titanium-containing catalysts.

The melting temperature of crystalline polyester resins is preferably in the range of 50° C. to 120° C. or about 50° C. to about 120° C., and more preferably in the range of 0° C. to 110° C. or about 0° C. to about 110° C.

Differential thermal analysis for finding the melting point is performed by the differential scanning calorimetry in conformity with ASTM D3418-8 as follows. A toner intended to be measured is set in differential scanning calorimetry (DSC) with a differential scanning calorimeter equipped with an automatic tangential treatment system (the name of instrument: DSC-50 type, manufactured by Shimadzu Corporation), and liquid nitrogen is set as a coolant. The toner is heated at 20 to 150° C. at a temperature-ascending rate of 10° C./min (the first temperature-ascending process), and the relationship between temperature (° C.) and calorie (mW) is found. Subsequently, the toner is cooled at a temperature-descending rate of 10° C./min to 0° C., and again heated at a temperature ascending rate of 10° C./min to 150° C. (the second temperature ascending process), and data are collected. The temperatures are retained for 5 minutes at 0° C. and 150° C. respectively. The endothermic peak temperature in the second temperature ascending process is taken as the melting temperature. There are cases where crystalline resins show a plurality of melting peaks, and the maximum peak is regarded as the melting temperature.

The molecular weight of the crystalline polyester resin is preferably in the range of 5,000 or more and 100,000 or less or about 5,000 or more and about 100,000 or less as weight average molecular weight (Mw) by molecular weight measurement according to the GPC method of a tetrahydrofuran (THF)-soluble content, more preferably in the range of 10,000 or more and 50,000 or less or about 10,000 or more and about 50,000 or less, the number average molecular weight (Mn) is preferably in the range of 2,000 or more and 30,000 or less or about 2,000 or more and about 30,000 or less, and more preferably in the range of 5,000 or more and 15,000 or less or about 5,000 or more and about 15,000 or less. The molecular weight distribution (Mw/Mn) is preferably in the range of 1.5 or more and 20 or less, and more preferably 2 or more and 5 or less. Since the solubility in THF of crystalline resins is not good, they are preferably dissolved by heating in a hot water bath at 70° C. in the measurement of molecular weight.

The acid value of the crystalline polyester resin is preferably in the range of 4 mg KOH/g or more and 20 mg KOH/g or less or about 4 mg KOH/g or more and about 20 mg KOH/g or less, and more preferably in the range of 6 mg KOH/g or more and 15 mg KOH/g or less or about 6 mg KOH/g or more and about 15 mg KOH/g or less. The hydroxyl group value of the crystalline polyester resin is preferably in the range of 3 mg KOH/g or more and 30 mg KOH/g or less, and more preferably in the range of 5 mg KOH/g or more and 15 mg KOH/g or less.

### (Coloring Agent)

As the coloring agents for use in the green toner according to the exemplary embodiment, green coloring agents by one kind alone, or mixtures of two or more kinds of green coloring agents, yellow coloring agents, and cyan coloring agents may be used. Pigments may be used as the coloring agents. Further, if necessary, dyes may be used. When two or more kinds of pigments are mixed, there are cases where turbidity is caused, so that it is preferred to use green pigments by one kind alone.

As green pigments (green series pigments), chromium oxide, chrome green, Pigment Green 7, Pigment Green 36, Malachite Green Lake, and Final Yellow Green are exemplified. As green pigments, Pigment Green 7 and Pigment Green 36 are preferably used, considering the use by one kind alone, Pigment Green 7 is preferred.

As yellow pigments (yellow series pigments), chrome yellow, zinc chrome, yellow iron oxide, cadmium yellow, chrome yellow, hansa yellow, Hansa Yellow 10G, Benzidine Yellow G, Benzidine Yellow GR, indanthrene yellow, Quinoline Yellow, and Permanent Yellow CG are exemplified. Specifically C.I. Pigment Yellow 74, C.I. Pigment Yellow 180, C.I. Pigment Yellow 93, C.I. Pigment Yellow 185, C.I. Pigment Yellow 155, C.I. Pigment Yellow 128, C.I. Pigment Yellow 111, and C.I. Pigment Yellow 17 are exemplified, and C.I. Pigment Yellow 74 and C.I. Pigment Yellow 185 are preferred from the point of pigment dispersibility.

As blue pigments (cyan series pigments), Berlin Blue, cobalt blue, alkali blue lake, Victoria Blue Lake, Fast Sky Blue, Indanthrene Blue BC, Aniline Blue, Ultramarine Blue, Chaloco Oil Blue, Methylene Blue Chloride, Phthalocyanine Blue, Phthalocyanine Green, and Malachite Green Oxalate are exemplified.

As the coloring agents for use in the toner sets according to the exemplary embodiment, the following are exemplified other than the above green coloring agents, yellow coloring agents and cyan coloring agents.

As black pigments, carbon black, copper oxide, manganese dioxide, Aniline Black, activated carbon, nonmagnetic ferrite, and magnetite are exemplified.

As magenta pigments, iron oxide red, cadmium red, red lead, mercury sulfide, Watchung Red, Permanent Red 4R, Lithol Red, Brilliant Carmine 3B, Brilliant Carmine 6B, Du Pont Oil Red, Pyrazolone Red, Rhodamine B Lake, Lake Red C, Rose Bengal, Eosine Red, and Alizarin Lake; as naphthol series pigments, C.I. Pigment Red 31, C.I. Pigment Red 146, C.I. Pigment Red 147, C.I. Pigment Red 150, C.I. Pigment Red 176, C.I. Pigment Red 238, and C.I. Pigment Red 269; and as quinacridone series pigments, C.I. Pigment Red 122, C.I. Pigment Red 202, and C.I. Pigment Red 209 are exemplified. Of these pigments, C.I. Pigment Red 185, C.I. Pigment Red 238, C.I. Pigment Red 269, and C.I. Pigment Red 122 are especially preferred,

As orange pigments, red chrome yellow, molybdenum orange, Permanent Orange GTR, Pyrazolone Orange, Vulcan Orange, Benzidine Orange G, Indanthrene Brilliant Orange RK, and Indanthrene Brilliant Orange GK are exemplified.

As red pigments, iron oxide red, cadmium red, red lead, mercury sulfide, Watchung Red, Permanent Red 4R, Lithol Red, Brilliant Carmine 3B, brilliant Carmine 6B, Du Pont Oil Red, Pyrazolone Red, Rhodamine B Lake, Lake Red C, Rose Bengal, Eosine Red, and Alizarin Lake are exemplified.

As violet pigments, manganese violet, Fast Violet B, and Methyl Violet Lake are exemplified.

As white pigments, Chinese white, titanium oxide, antimony white, and zinc sulfide are exemplified.

As extender pigments, baryta powder, barium carbonate, clay, silica, white carbon, talc and alumina white are exemplified.

If necessary, dyes may be used as the coloring agents. As the dyes, various dyes such as basic, acidic, dispersing and direct dyes may be used, e.g., nigrosine, Methylene Blue, Rose Bengal, Quinoline Yellow, and Ultramarine Blue are exemplified. These may be used alone, as mixture, or in the state of solid solution.

The content of the coloring agent in the green toner according to the exemplary embodiment is preferably in the range of 0.5 wt % or more and 8 wt % or less or about 0.5 wt % or more and about 8 wt % or less on the basis of the entire weight of the toner, and more preferably in the range of 1 wt % or more and 4 wt % or less or about 1 wt % or more and about 4 wt % or less. When the content is less than 0.5 wt %, there is a case where the density is too thin and the effect of compensating for cyan color cannot be obtained, while when the content exceeds 8 wt %, the density is too high and sometimes the effect in the low image density part cannot be obtained.

The content of the coloring agent in the toner other than the green toner in the toner set according to the exemplary embodiment is, e.g., preferably in the range of 1 wt % or more and 15 wt % or less on the basis of the entire weight of the toner, and more preferably in the range of 3 wt % or more and 12 wt % or less.

The dispersion size of the pigment in the green toner according to the exemplary embodiment is, e.g., preferably in the range of 30 nm or more and 300 nm or less or about 30 nm or more and about 300 nm or less, and more preferably in the range of 60 nm or more and 200 nm or less or about 60 nm or more and about 200 nm or less. When the dispersion size is less than 30 nm, there is a case where the toner is conspicuous viscous, and when the dispersion size exceeds 300 nm, there is a case where the pigment is bared on the surface of the toner and charging property is deteriorated.

### (Release Agent)

It is preferred for the toner according to the exemplary embodiment to contain a release agent. As the release agents to be used, materials having a subjective. maximum endothermic peak measured with a DSC in conformity with ASTM D3418-8 of 60° C. or more and 120° C. or less or about 60° C. or more and about 120° C. or less, and melting viscosity of 1 mPas or more and 50 mPas or less or about 1 mPas or more and about 50 mPas or less at 140° C. are preferred.

It is preferred that the heat absorption stating temperature in the DSC curve measured by a differential scanning calorimeter of the release agent is 40° C. or more, and more preferably 50° C. or more. The heat absorption starting temperature varies according to the molecules having a low molecular weight, and the kinds and the amounts of the polar groups of the structures thereof among the molecular weight distribution constituting the wax. In general, the heat absorption starting temperature rises with the melting temperature as the molecular weight increases. However, a low melting temperature and low viscosity natural to wax (release agent) are sometimes damaged with this method. Accordingly, of the molecular weight distribution of the wax, it is effective to select and remove the molecules of a low molecular weight. Methods such as molecular distillation, solvent fractionation and gas chromatography fractionation are used for the removal. DSC measurement is as described above.

The melt viscosity of the release agent is measured with an E-type viscometer. In measurement, an E-type viscometer equipped with an oil circulating thermostatic chamber (manufactured by Tokyo Keiki Co., Ltd.) is used. In measurement, a plate of a combination of a cone plate having a cone angle of 1.34° and a cup is used. A sample is put in the cup, the temperature of the circulation system is set at 140° C., the empty measuring cup and the cone are set in the measuring instrument, and the temperature is maintained constant while circulating oil. When the temperature is stabilized, 1 g of a sample is put in the measuring cup, and the cone is allowed to stand in a still state for 10 minutes. After stabilization, the cone is rotated and measurement is carried out. The rotational speed is 60 rpm. The measurement is performed three times and the average value is taken as melting viscosity η.

The specific examples of the release agents include, for example, low molecular weight polyolefins, e.g., polyethylene, polypropylene, polybutene, etc.; silicones showing a softening temperature by heating; fatty acid amides, e.g., oleic acid amide, erucic acid amide, ricinoleic acid amide, stearic acid amide, etc.; vegetable waxes, e.g., carnauba wax, rice wax, candelida wax, Japan wax, jojoba oil, etc.; animal waxes, e.g., bees wax, etc.; ester waxes, e.g., fatty acid ester, montanic acid ester, etc.; mineral and petroled waxes, e.g., montan wax, ozokerite, ceresine, paraffin wax, microcrystalline wax, Fischer-Tropsch wax, etc.; and modified products of them.

The addition amount of the release agent is preferably 1 mass part or more and 15 mass parts or less or about 1 mass part or more and about 15 mass parts or less to 100 mass parts of the binder resin, and more preferably 3 mass parts or more and 10 mass parts or less or about 3 mass parts or more and about 10 mass parts or less. When the addition amount of the release agent is less than 1 mass part, sometimes the effect of the release agent is not exhibited, while when the amount is larger than 15 mass parts, flowability is deteriorated and there is a case where charge distribution becomes very broad.

### (Other Components)

The toner according to the exemplary embodiment may contain, if necessary, inorganic or organic particles. As the inorganic particles, silica, bydrophobitization treated-silica, alumina, titanium oxide, calcium carbonate, magnesium caronate, tricalcium phosphate, colloidal silica, alumina treated-colloidal silica, surface-treated colloidal silica with cation, or surface-treated colloidal silica with anion may be used alone or in combination, and it is especially preferred to use colloidal silica. The volume average particle size is preferably 5 nm or more and 50 nm or less. Particles having different particle sizes may be used in combination. These particles may be directly added at the time of manufacture of the toner, but it is preferred to use dispersion obtained by dispersing the particles in advance in an aqueous medium such as water with an ultrasonic wave disperser. Dispersibility may be improved with ionic surfactants, polymeric acids or polymeric bases in dispersing process.

Known materials such as a charge controlling agent may be added to the toner. The volume average particle size of the material to be added is preferably 1 μm or less, and more preferably 0.01 μm or more and 1 μm or less. Incidentally, the volume average particle size is measured, e.g., with a micro-track and the like.

### <Manufacturing Method of Electrostatic Image Developing Toner>

In manufacturing the electrostatic image developing toner according to the exemplary embodiment, generally used kneading and grinding methods and wet granulating methods may be used. As the wet granulating methods, a suspension polymerization method, an emulsification polymerization method, an emulsification polymerization aggregation method, a soap-free emulsification polymerization method, a non-aqueous dispersion polymerization method, an in-situ polymerization method, an interfacial polymerization method, an emulsification dispersion granulating methods and an aggregation-coalescence method are exemplified. In the point of including the crystalline resin within the toner, wet granulating methods are preferably used.

As the wet granulating methods, known melt suspension method, emulsification aggregation method, and dissolution suspension method are preferably exemplified. Wet granulating methods are explained below by the emulsification aggregation method as an example.

The emulsification aggregation method is a manufacturing method comprising a process of preparing aggregated particle dispersion by forming aggregated particles in dispersion having dispersed therein at least resin particles (which is sometimes referred to as “emulsified liquid”) (an aggregation process), and a process of fusing the aggregated particles by heating the aggregated particle dispersion (a fusion process). Further, a process of dispersing the aggregated particles (a dispersion process) may be provided before the aggregation process, or a process of forming adhered particles by adding particle dispersion having dispersed therein particles to the aggregated particle dispersion and mixing to adhere the particles to the aggregated particles (an adhesion process) may be provided between the aggregation process and the fusion process. In the adhesion process, adhered particles are formed by adding particle dispersion to the aggregated particle dispersion prepared in the aggregation process and adhering the particle dispersion to the aggregated particle dispersion. The added particles are newly added particles to the aggregated particles, so that these particles are sometimes referred to as “additional particles”.

The additional particles may comprise alone or a combination of a plurality of release agent particles and coloring agent particles besides the resin particles. The method of additionally adding the particle dispersion is not especially restricted and, for example, the dispersion may be added gradually and continuously, or the dispersion may be divided and added stepwise in a plurality of times. By providing the adhesion process, pseudo shell structure is formed.

In the toner according to the exemplary embodiment, it is preferred to form a core/shell structure by the operation of adding additional particles. The binder resin that is the main component of the additional particles is the resin for shell layers. According to this method, control of the toner shape can be easily performed by the adjustments of the temperature, rotating number and pH in the fusion process.

In the emulsion aggregation method, it is preferred to use the crystalline polyester resin dispersion and amorphous polyester resin dispersion in combination. It is more preferred to provide an emulsification process for forming emulsified particles (droplets) by emulsifying amorphous polyester resin.

In the emulsification process, emulsified particles (droplets) of the amorphous polyester resin are formed by giving shear force to the solution obtained by mixing an aqueous medium and the mixed solution (polymer solution) containing the amorphous polyester resin and the coloring agent according to necessity. At that time, emulsified particles may be formed by heating the amorphous polyester resin at a temperature higher than the glass transition temperature of the amorphous polyester resin to lower the viscosity of the polymer solution. Further, a dispersant may be used. Hereinafter, such dispersion of emulsified particles is sometimes referred to as “amorphous polyester resin dispersion”.

As the emulsifier for forming the emulsified particles, a homogenizer, a homomixer, a pressure kneader, an extruder, and a media disperser are exemplified. The size of the emulsified particles (droplets) of the polyester resin is preferably 0.005 μm or more and 0.5 μm or less as an average particle size (a volume average particle size), and more preferably 0.01 μm or more and 0.3 μm or less. The volume average particle size of resin particles is measured with a Doppler scattering type particle size distribution meter (Microtrack UPA9340, manufactured by NIKKISO CO., LTD.).

When the melt viscosity of the resin at the time of emulsification is high, the particle size does not decrease to a desired particle size. Accordingly, amorphous polyester resin dispersion having a desired particle size may be obtained by performing emulsification with an emulsifier capable of increasing pressure higher than the atmospheric pressure to increase temperature and decrease resin viscosity.

In the emulsification process, a method of adding a solvent to the resin in advance for the purpose of lowering the viscosity of the resin may be used. The solvents for this purpose are not especially restricted so long as they can dissolve the resin, and ketone series solvents such as tetrahydrofuran (THF), methyl acetate, ethyl acetate, methyl ethyl ketone, and benzene series solvents such as benzene, toluene, and xylene are used. Ester series solvents and ketone series solvents such as ethyl acetate and methyl ethyl ketone are preferably used.

Alcohol solvents such as ethanol and isopropyl alcohol may be directly added to water or resin. Salts such as sodium chloride and potassium chloride, or ammonia may also be added. Of these solvents, ammonia is preferably used.

A dispersant may be added. As the dispersants, water-soluble polymers, e.g., polyvinyl alcohol, methyl cellulose, carboxymethyl cellulose, sodium polyacrylate, etc.; surfactants, such as anionic surfactants, e.g., sodium dodecylbenzenesulfonate, sodium octadecylsulfate, sodium oleate, sodium laurate, potassium stearate, etc.; cationic surfactants, e.g., laurylamine acetate, lauryltrimethylammonium chloride, etc.; amphoteric ionic surfactants, e.g., lauryldimethylane oxide, etc.; and nonionic surfactants, e.g., polyoxyethylene alkyl ether, polyoxyethylene alkylphenyl ether, polyoxyethylene-alkylamine, etc.; and inorganic compounds, e.g., tricalcium phosphate, aluminum hydroxide, calcium sulfate, calcium carbonate, barium carbonate, etc., are exemplified. Of these dispersants, anionic surfactants are preferably used. The use amount of the dispersants is preferably 0.01 mass parts or more and 20 mass parts or less to 100 mass parts of the polyester resin (the binder resin). However, since dispersants in many cases affect a charging property, they are not preferably added, so long as an emulsification property can be ensured by the hydrophilic property of the main chain of the polyester resin, acid values of terminals, and the quantity of the value of hydroxyl groups.

In the emulsification process, the crystalline polyester resin may be copolymerized in advance with dicarboxylic acid having a sulfonic acid group (that is, the component derived from dicarboxylic acid having a sulfonic acid group is contained in an appropriate amount in the components derived from acids). The addition amount of the dicarboxylic acid is preferably 10 mol % or less in acid components, but the dicarboxylic acid is not preferably added, so long as an emulsification property can be ensured by the hydrophilic property of the main chain of the polyester resin, acid values of terminals, and the quantity of the value of hydroxyl groups.

Phase inversion emulsification may be used in the formation of emulsified particles. The phase inversion emulsification is a method of dissolving at least amorphous polyester resin in a solvent, adding. If necessary, a neutralizer and a dispersion stabilizer, dripping an aqueous medium while using to obtain emulsified particles, and then removing the solvent in the resin dispersion to obtain an emulsified liquid. At this time, the orders of addition of the neutralizer and the dispersion stabilizer may be changed.

As solvents for dissolving resins, formates, acetates, butyrates, ketones, ethers, benzenes, and carbon halogenides are exemplified. Specifically, formic acid, acetic acid, butyric acid esters of methyl, ethyl, n-propyl, isopropyl, n-butyl, isobutyl, sec-butyl, t-butyl, etc.; methyl ketones e.g., acetone, methyl ethyl ketone (MEK), methyl propyl ketone (MPK), methyl isopropyl ketone (MIPK), methyl butyl ketone (MBK), methyl isobutyl ketone (MIBK), etc.; ethers, e.g., diethyl ether, diisopropyl ether, etc.; heterocyclic substitution products, e.g., toluene, xylene, bene, etc.; and carbon halogenides, e.g., carbon tetrachloride, methylene chloride, 1,2-dichloroethane, 1,1,2-trichloroethane, trichloroethylene, chloroform, monochlorobenzene, dichloroethylidene, etc., are exemplified, and these solvents may be used by one kind alone, or two or more kinds in combination. Of these solvents, acetic esters, methyl ketones and ethers of low boiling temperature solvents are generally preferably used, and acetone, methyl ethyl ketone, acetic acid, ethyl acetate, butyl acetate are especially preferred. It is preferred to use relatively highly volatile solvents so as not to remain behind in the resins. The use amount of these solvents is preferably in the range of 20 mass % or more and 200 mass % or less on the basis of the amount of the resin, and more preferably in the range of 30 mass % or more and 100 mass % or less.

As the aqueous medium, it is preferred fundamentally to use ion exchange water, but a water-soluble solvent may be contained in a degree of not breaking oil droplets. As the water-soluble solvents, alcohols having a short carbon chain e.g., methanol, ethanol, 1-propanol, 2-propanol, 1-butanol 2-butanol, t-butanol, 1-pentanol, etc.; ethylene glycol monoalkyl ethers, e.g., ethylene glycol monomethyl ether; ethylene glycol monoethyl ether, ethylene glycol monobutyl ether, etc.; ethers, diols, tetrahydrofuran (THF), acetone, etc., are exemplified, and ethanol and 2-propanol are preferably used. The use amount of these water-soluble solvents is preferably in the range of 1 mass % or more and 60 mass % or less on the basis of the amount of the resin, and more preferably in the range of 5 mass % or more and 40 mass % or less. Water-soluble solvents may be mixed with ion exchange water to be added to or may be added to the resin-dissolving solution, either will do.

If necessary, a dispersant may be added to an amorphous polyester resin solution and an aqueous component. The dispersants are those that form hydrophilic colloid in the aqueous component, and cellulose derivatives, e.g., hydroxymethyl cellulose, hydroxyethyl cellulose, hyroxypropyl cellulose, etc.; synthetic polymers, e,g., polyvinyl alcohol, polyvinyl pyrrolidone, polyacrylamide, polyacrylate, polymethacrylate, etc.; and dispersion stabilizers, e.g., gelatin, gum arabic, agar-agar, etc., are particularly exemplified. Further, solid powders, such as silica, titanium oxide, alumina tricalcium phosphate, calcium carbonate, calcium sulfate, barium carbonate, etc., may be used. These dispersion stabilizers are generally added so that the concentration in the aqueous component preferably falls in the range of 0 mass % or more and 20 mass % or less, and more preferably 0 mass % or more and 10 mass % or less.

As the dispersants, surfactants may be used. As the examples of the surfactants, those corresponding to the surfactants used in the coloring agent dispersion described later may be used. For example, besides natural surfactants such as saponin, cationic surfactants, e.g., alkylamine hydrochloride-acetates, quaternary ammonium salts, glycerin, etc.; and anionic surfactants, e.g., fatty acid soaps, sulfates, alkylnaphthalenesulfonates, sulfonates, phosphoric acid, phosphate, sulfosuccinates, etc., are exemplified, and anionic surfactants and nonionic surfactants are preferably used. A neutralizer may be used for adjusting pH of the emulsified liquid. As the neutralizers, ordinarily used acids and alkalis, e.g., nitric acid, hydrochloric acid, sodium hydroxide, and ammonia may be used.

As the method of removing solvents from the emulsified liquid, a method of volatilizing the solvents at a temperature of 15 to 70° C., and a method of combining pressure reduction with the above method are preferably used. In the exemplary embodiment, from the viewpoints of particle size distribution and particle size control, a method of emulsifying by phase inversion emulsification and then removing the solvents by heating under reduced pressure is preferably used. For applying to toners, from the aspect of the influence on a charging property, dispersants and surfactants are not preferably added, so long as an emulsification property can be ensured by the hydrophilic property of the main chain of the polyester resin, acid values of terminals, and the quantity of the value of hydroxyl groups.

The methods for dispersing the coloring agents and release agents are not especially restricted and it is sufficient to use generally used dispersing methods, such as methods of using a high pressure homogenizer, a rotating shearing type homogenizer, an ultrasonic wave disperser, a high pressure impact type disperser, a ball mill having media, a sand mill, or a Dyno-mill.

If necessary, an aqueous dispersion of a coloring agent may be prepared with a surfactant, or organic solvent dispersion of a coloring agent may be prepared with a dispersant. Hereinafter these dispersions are sometimes referred to as “coloring agent dispersion” and “release agent dispersion”.

The dispersants for use in coloring agent dispersion and release agent dispersion are generally surfactants. As preferred surfactants, anionic surfactants, such as sulfuric ester, sulfonic ester, phosphoric ester, soaps, etc.; cationic surfactants, such as an amine salt type, a quaternary ammonium salt type, etc.; and nonionic surfactants, such as polyethylene glycol, alkylphenyl ethylene oxide adducts, polyhydric alcohols, etc., are exemplified. Of these surfactants, ionic surfactants are preferred, and anionic surfactants and cationic surfactants are more preferred. It is preferred that the nonionic surfactants are used in combination with the anionic surfactant or cationic surfactant. These surfactants may be used by one kind alone, or two or more kinds may be used in combination.

As the specific examples of the anionic surfactants, fatty acid soaps, e.g., potassium laurate, sodium oleate, sodium castor oil, etc.; sulfates, e.g., octyl sulfate, lauryl sulfate, lauryl ether sulfate, nonyl phenyl ether sulfate etc.; sodium alkylnaphthalene sulfonates, e.g., lauryl sulfonate, dodecyl sulfonate, dodecylbenzene sulfonate, trilsopropylnaphthalene sulfonate, dibutylnaphthalene sulfonate, etc.; sulfonates, e.g., naphthalene sulfonate-formalin condensation product, monooctyl sulfosuccinate, dioctyl sulfosuccinate, lauric acid amide sulfonate, oleic acid amide sulfonate, etc.; phosphates, e.g., lauryl phosphate, isopropyl phosphate, nonyl phenyl ether phosphate, etc.; dialkyl sodium sulfosuccinate, e.g., dioctyl sodium sulfosuccinate, etc.; and sulfosuccinate, e.g., lauryl disodium sulfosuccinate, lauryl disodium polyoxyethylene sulfosuccinate, etc., are exemplified. Of these surfactants, dodecylbenzenesilfonate, and alkylbenzenesulfonate, which is a branched compound of dodecylbenzenesulfonate are preferred.

As the specific examples of the cationic surfactants, amine salts, e.g., laurylamine hydrochloride, stearylamine hydrochloride, oleylamnine acetate, stearylamine acetate, stearylaminopropylamie acetate, etc.; and quaternary ammonium salts, e.g., lauryl trimethylammonim chloride, dilauryl dimethylammonium chloride, distearylammonium chloride, distearyl dimethylammonium chloride, lauryl dihydroxyethylmethylammonium chloride, oleyl-bispolyoxy-ethylene methylammonium chloride, lauroylaminopropyl dimethylethylammonium ethosulfate, lauroylaminopropyl dimethylhydroxyethylammonium perchlorate, alkylbenzene dimethylammonium chloride, alkyl trimethylammonium chloride, etc., are exemplified.

As the specific examples of the nonionic surfactants, alyl ethers, e.g., polyoxyethylene octyl ether, polyoxyethylene lauryl ether, polyoxyethylene stearyl ether, polyoxyethylene oleyl ether, etc., alkyl phenyl ethers, e.g., polyoxyethylene octyl phenyl ether, polyoxyethylene nonyl phenyl ether, etc.; alkyl esters, e.g., polyoxyethylene laurate, polyoxyethylene stearate, polyoxyethylene oleate, etc.; alkylamines, e.g., polyoxyethylene lauryl amino ether, polyoxyethylene stearyl amino ether, polyoxyethylene oleyl amino ether, polyoxyethylene soybean amino ether, polyoxyethylene beef tallow amino ether, etc.; alkylamides, e.g., polyoxyethylene lauric acid amide, polyoxyethylene stearic acid amide, polyoxyethylene oleic acid amide, etc.; vegetable oil ethers, e.g., polyoxyethylene castor oil ether, polyoxyethylene rape oil ether, etc.; alkanolamides, e.g., lauric acid diethanolamide, stearic acid diethanolamide, oleic acid diethanolamide, etc.; and sorbitan ester ethers, e.g., polyoxyethylene sorbitan monolaurate, polyoxyetbylene sorbitan monopalmitate, polyoxyethylene sorbitan monostearate, polyoxyethylene sorbitan monooleate, etc., are exemplified.

The addition amount of the dispersant to be used is preferably 2 mass % or more and 30 mass % or less on the basis of the coloring agents and the release agents, and more preferably 5 mass % or more and 20 mass % or less.

The aqueous dispersion to be used is preferably low in contents of impurties, such as distilled water and ion exchange water. Alcohols may be added to the aqueous dispersion. Polyvinyl alcohol and a cellulose series polymer may be added, but preferably they are not contained as far as possible, so as not to remain behind.

Methods for manufacturing dispersions of various additives are not especially restricted. For example, a rotating shearing type homogenizer, a ball mill, a sand mill, and a Dyno-mill each having media, and in addition to these apparatus, other well-known apparatus used in dispersing the coloring agents and release agents are exemplified, and optimal apparatus may be selected and used.

In the aggregation process, it is preferred to use an aggregating agent for forming aggregated particles. As the aggregating agents, surfactants of reversed polarity to the surfactants used as the dispersants, ordinary inorganic metal compounds (inorganic metal salts) or polymers thereof are exemplified. The metal elements constituting the inorganic metal salts are those having divalent or higher charge and belonging to Groups 2A, 3A, 4A, 5A, 6A, 7A, 8, 1B, 2B, and 3B of the Periodic Table (long term Periodic Table), and those dissolved in the form of ion in the resin particle aggregation.

The specific examples of the inorganic metal salts include metal salts such as calcium chloride, calcium nitrate, barium chloride, magnesium chloride, zinc chloride, aluminum chloride, and aluminum sulfate, and inorganic metal salt polymers such as aluminum polychloride, aluminum polyhydroxide, and calcium polysulfide. Of these, aluminum salts and polymers thereof are especially preferred. For obtaining sharper particle size distribution, metal salts having valence of divalent better than monovalent, and trivalent than divalent, and inorganic metal salt polymers of even with the same valence are more suitable.

The addition amount of the aggregating agent fluctuates according to the kind and valence of the aggregating agent, but is generally preferably in the range of 0.05 mass % or more and 0.1 masses or less. Not all addition amount remains in the toner, a part flows out into the aqueous medium during the process of manufacturing the toner, or crude powder is formed. In particular, when a large amount of solvent is contained in the resin in the manufacturing process of the toner, the solvent and the aggregating agent interact to each other and the aggregating agent is liable to flow out into the aqueous medium. Therefore, it is preferred to adjust the amount of the aggregating agent to the remaining amount of the solvent.

It is preferred that the toner according to the exemplary embodiment contains at least one metal element selected from aluminum, zinc and calcium in terms of composition ratio of element of 0.003 mass % or more and 0.05 mass % or less as this is ascribable to the addition of the aggregating agent. The content of the metal element is found from all element analysis by a fluorescent X-ray apparatus. As the sample, 6 g of toner is press molded with a pressure molder by a load of 10t, and press time of 1 minute. The content is found from the composition ratio of the element measured with a fluorescent X-ray apparatus (XRF-1500, manufactured by Shimadzu Corporation), measuring condition of lamp voltage of 40 kV, tube current of 90 mA, and measuring time of 30 minutes.

In the fusion process, aggregated particles are fused and coalesced by making the pH of the suspension of aggregate 5 or more and 10 or less to stop the progress of aggregation, and heating at the temperature higher than the glass transition temperature (Tg) of the resin (or the temperate higher than the melting temperature of the crystalline resin). Heating time is almost the same with the time to finish desired coalescence, i.e., 02 to 10 hours. After that, in solidifying the particles by temperature descending to Tg of the resin or lower, there is a case where the shape of the particles and surface properties change according to the temperature descending rate. It is preferred that the temperature is descended to Tg of the resin or lower at a rate of at least 0.5° C./min or more, and it is more preferred that the temperature is descended to Tg of the resin or lower at a rate of 1.0° C./min or more.

The aggregation process and the fusion process can be performed at the same time by growing the particles by pH and addition of an aggregating agent according to the aggregation process with heating at a temperature of Tg of the resin or higher to reach a desired particle size, and then descending the temperature to Tg of the resin or lower at a rate of at least 0.5° C./min according to the case of the fusion process to stop the growth of the particles at the same time with solidification of the particles. This method is preferred in the point of capable of simplifying the processes, but sometimes it is difficult to form the core/shell structure.

After finishing the fusion process, the particles are washed and dried, and toner particles are obtained. It is preferred to perform substitution washing with ion exchange water. The degree of washing is generally monitored by the conductivity of the filtrate, and it is preferred that the conductivity is finally 25 μS/cm or less. In washing, a process of neutralization of the ion with acid or alkali may be included, and pH is preferably made 4.0 or less by the treatment with acid, and 8.0 or more by the treatment with alkali. Solid-liquid separation after washing is not especially restricted but suction filtration and pressure filtration such as filter press are preferably used from the productivity. Further, a drying method is also not especially limited but, in view of productivity, freeze drying, flash jet drying, fluidized drying, and vibrating type fluidized drying are preferably used. Drying is performed to reach the final moisture content of the toner of preferably 1 mass % or less, and more preferably 0.7 mass % or less.

To the thus-obtained toner particles may be externally added a flowability assistant, a cleaning assistant, and inorganic and organic particles as abrasives. As the inorganic particles, all particles used as external additives of ordinary toner surface, such as silica, alumina, titanium oxide, calcium carbonate, magnesium carbonate, tricalcium phosphate, and cerium oxide are exemplified. The surfaces of these inorganic particles are preferably hydrophobitized. As the organic particles, all particles used as external additives of ordinary toner surface, such as vinyl resins, e.g., syrene polymers, (meth)acrylic polymers, ethylene polymers, etc., polyester resin, silicone resin, fluorine resin, etc., are exemplified.

The primary particle sizes of these particles are preferably 0.01 μm or more and 0.5 μm or less. A lubricant may further be added. As the lubricants, fatty acid amide, e.g., ethylenebisstearic acid amide, oleic acid amide, etc., and higher alcohol, such as fatty acid metal salt Unilin, e.g., zinc stearate, calcium stearate are exemplified. The primary particle size thereof is preferably 0.5 μm or more and 8.0 μm or less.

Of the inorganic particles, at least two or more kinds are used, and at least one of these inorganic particles has an average primary particle size of preferably 30 nm or more and 200 nm or less, and more preferably 30 nm or more and 180 nm or less.

Specifically, silica, alumina and titanium oxide are preferred, and it is especially preferred to add hydrophobitized silica as essential component. To use silica and titanium oxide in combination is particularly preferred. It is also preferred to use in combination of organic particles having a particle size of 80 nm or more and 500 nm or less. As hydrophobitizing agents for hydrophobitizing treatment of eternal additives, known materials, such as coupling agents, e.g., a silane coupling agent, a titarate coupling agent, an aluminate coupling agent, and a zirconate coupling agent, silicone oil and polymer coating treatment are exemplified.

The external additives may be adhered or fixed on the surface of the toner by applying mechanical impact force with a V blender, a sample mill, or a Henschel mixer.

### <Physical Characteristics of Electrostatic Image Developing Toner>

The volume average particle size of toners is preferably in the range of 4 μm or more and 9 μm or less or about 4 μm or more and about 9 μm or less, more preferably in the range of 4.5 μm or more and 8.5 μm or less or about 4.5 μm or more and about 8.5 μm or less, and still more preferably in the range of 5 μm or more and 8 μm or less or about 5 μm or more and about 8 μm or less.

When the cumulative distributions of the volume and the number are drawn from the small size side with respect to the particle size ranges (channels) divided based on the particle size distribution, and the particle size giving accumulation of 16% is defined as D16%, the particle size giving accumulation of 50% is defined as D50%, and the particle size giving accumulation of 84% is defined as D84%, the volume average particle size distribution index (GSDv) of the above toner computed from (D84%//D16%)^{1/2} by the following method is preferably 1.15 or more and 1.30 or less, and more preferably 1.15 or more and 1.25 or less.

The volume average particle size, etc., are measured with Multisizer II (manufactured by Beckmann Coulter, Inc.) with an aperture of 50 μm. At this time, the measurement is performed after dispersing the toner in an electrolytic aqueous solution (Isoton aqueous solution) (concentration: 10 mass %) and dispersing by ultrasonic wave for 30 seconds or more. With respect to the particle size distribution, the cumulative distributions of the volume and the number are drawn from the small size side with respect to the particle size ranges divided based on the particle size distribution measured with Multisizer II (number of division: from 1.26 μm to 50.8 μm is divided to 16 channels so as to be 0.1 interval as log scale, specifically channel 1 is from 1.26 μm to less than 1.59 μm, channel 2 is from 1.59 μm to less than 2.00 μm, channel 3 is from 2.00 μm to less than 2.52 μm . . . , and divided so that the log values of the lower limit numerical values on the left side become (log 1.26=)0.1, (log 1.59=)0.2, (log 2.00=)0.3, . . . , 1.6). The particle size giving accumulation of 16% is defined as D₁₆ᵥ for volume and D₁₆ₚ for number, the particle size giving accumulation of 50% is defined as D₅₀ᵥ for volume and D₅₀ₚ for number, and the particle size giving accumulation of 84% is defined as D₈₄ᵥ for volume and D₈₄ₚ for number.

The particle shape of the above toner is preferably spherical having shape factor SF1 falling in the range of 110 or more and 145 or less or about 110 or more and about 145 or less. When the shape is spherical falling in this range, transfer efficiency and minuteness of image are improved, and a high quality image is formed. The above shape factor SF1 is more preferably in the range of 110 or more and 140 or less or about 110 or more and about 140 or less.

The above shape factor SF1 is found from the following equation.

$$S F 1 = \frac{{( M L )}^{2}}{A} \times \frac{π}{4} \times 100$$

In the formula, ML represents the absolute maximum length of a toner particle, and A represents the projected area of a toner particle.

Microphotographs or scanning electron microscopic (SEM) images are analyzed with an image analyzer, and SF1 is expressed as a numerical value. SF1 is computed, for example, as follows. An optical micrograph of the toner scattered on the surface of a slide glass is imported into an image analyzer, LUZEX, through a video camera, and the maximum lengths and the projected areas of 100 toner particles are found, computed according to the above equation, and SF1 is obtained by finding the average value.

When the shape factor SF1 is smaller than 110 or larger than 145, there are cases where excellent charging property, cleaning property and transferability cannot be obtained for long duration.

### <Electrostatic Image Developer and Electrostatic Image Developer Set>

In the exemplary embodiment, the electrostatic image developer is not especially restricted except for containing the electrostatic image developing green toner of the exemplary embodiment, and arbitrary composition of components can be taken according to purpose. The electrostatic image developer in the exemplary embodiment is used as it is as a one-component developer, or as a two component developer in combination with a carrier.

In the exemplary embodiment, an electrostatic image developer set contains at least a cyan developer containing a cyan toner, a yellow developer containing a yellow toner, and a green developer containing a green toner. The developer set may further contain a magenta developer containing a magenta toner and a black developer containing a black toner. Each developer is used as it is as a one-component developer, or as a two-component developer in combination with a carrier.

The carrier is preferably a carrier covered with a resin, and more preferably a carrier covered with a nitrogen-containing resin. As the nitrogen-containing resins, acryl resins containing dimethylaminoethyl methacrylate, dimethyl acrylamide, acrylonitrile, etc., amino resins containing urea, urethane, melamine, guanamine, aniline, etc., and amide resins and urethane resins are exemplified. The resins may be copolymer resins of these resins. As the covering resin of the carrier, two or more resins may be combined from among the nitrogen-containing resins. Further, the nitrogen-containing resin and a resin not containing nitrogen may be used in combination. Resins obtained by granulating the nitrogen-containing resin and dispersing in a resin not containing nitrogen may be used. Urea resins, urethane resins, melamine resins and amide resins are especially preferred.

In general, for a carrier to have a proper electrical resistance value, and specifically an electrical resistance value of 10⁹ Ωcm or more and 10¹⁴ Ωcm or less or about 10⁹ Ωcm or more and about 10¹⁴ Ωcm or less is required. For example, when an electrical resistance value is as low as 10⁶ Ωcm like iron powder carrier, it is desired to have an insulating resin cover (volume resistivity is 10¹⁴ Ωcm or more) and disperse conductive powder in the resin cover.

As the specific examples of the conductive powders, metals such as gold, silver, copper, etc.; carbon black; semiconductive oxides such as titanium oxide, zinc oxide, etc.; powders such as titanium oxide, zinc oxide, barium sulfate, aluminum borate, potassium titanate, etc., the surfaces of which are covered with tin oxide, carbon black, or metal, are exemplified. Of these conductive powders, carbon black is preferred.

As methods of forming the resin cover layer on the surface of a carrier core material, an immersion method of immersing the powder of a carrier core material in a cover layer-forming solution, a spray method of spraying a cover layer-forming solution on the surface of a carrier core material, a fluidized bed method of spraying a cover layer-forming solution while maintaining a carrier core material floating with fluidized air, a kneader coater method of mixing a carrier core material and a cover layer-forming solution in a kneader coater and removing a solvent, and a powder coating method of granulating a cover resin, mixing the granulated powder and a carrier core material in a kneader coater at a temperature higher than the melting temperature of the cover resin, and cooling to form a cover are exemplified. Of these methods, a kneader coater method and a powder coating method are especially preferably used. The thickness of the resin cover layer formed by these methods is generally preferably in the range of 0.1 μm or more and 10 μm or less, and more preferably in the range of 0.2 μm or more and 5 μm or less.

The material used for the carrier (carrier core material) is not especially restricted, and magnetic metals, e.g., iron, steel, nickel, cobalt, etc.; magnetic oxides, e.g., ferrite, magnetite, etc.; and glass beads are exemplified. When a magnetic brush method is used, magnetic carrier is especially preferred. The volume average particle size of the carrier core material is generally preferably 10 μm or more and 100 μm or less, and more preferably 20 μm or more and 80 μm or less.

As the mixing ratio (by ratio) of the toner and the carrier in the two-component developer is preferably in the range of toner/carrier of 1/100 or more and 30/100 or less or so, and more preferably in the range of 3/100 or more and 20/100 or less or so.

In the manufacture of the carrier, a heating type kneader, a heating type Henschel mixer, a UM mixer may be used, and according to the amount of the cover resin, a heating type fluidized rolling bed and a heating type kiln may be used.

The mixing ratio of the electrostatic image developing toner of the exemplary embodiment in the electrostatic image developer is not especially restricted and it may be optionally selected according to the purpose.

### <Image Forming Apparatus and Image Forming Method>

An example of the image-forming apparatus and an image-forming method in the exemplary embodiment will be described below. However, the image-forming apparatus is an example, and the exemplary embodiment is not restricted thereto.

The image-forming method according to the exemplary embodiment comprises an image holding member, a latent image-forming unit of forming an electrostatic latent image on the surface of the image holding member, a developing unit of forming a toner image by developing the electrostatic latent image with a developer containing a toner, a first transfer unit of first transferring the developed toner image to an intermediate transfer-receiving member, and a second transfer unit of second transferring the toner image transferred to the intermediate transfer member to a recording member. Further, the image-forming method according to the exemplary embodiment may include units other than the above units, for example, a charging unit of charging the image holding member, a fixing unit of fixing the toner image transferred to the surface of the recording member, and a cleaning unit of removing the toner remained on the surface of the image holding member.

A schematic drawing showing an example of the image-forming apparatus in the exemplary embodiment of the invention is shown in the drawing. Image forming apparatus 200 is constituted of image holding member 201, charger 202 of a charging unit, image writing unit 203 of a developing unit, rotary developing unit 204 of a developing unit, first transfer roll 205 of a first transfer unit, cleaning blade 206 of a cleaning unit, intermediate transfer member 207 of transferring the toners of two or more colors at a time, a plurality of support rolls 208, 209, 210, and second transfer roll 211 of a second transfer unit.

Image holding member 201 is formed in drum-like as a whole, and has a photosensitive layer on the periphery (on the surface of the drum). Image holding member 201 is provided so as to be capable of rotating in the direction of arrow C in the drawing. Charger 202 is for charging the surface of image holding member 201 evenly. Image writing unit 203 is for forming an electrostatic latent image by irradiating image holding member 201 evenly charged with charger 202.

Rotary developing unit 204 has five developing units 204Y, 204M, 204C, 204K and 204G for containing toners for yellow, magenta, cyan, black and green. Since this apparatus uses toners in developers for image formation, developing unit 204Y contains a yellow toner, developing unit 204M contains a magenta toner, developing unit 204C contains a cyan toner, developing unit 204K contains a black toner, and developing unit 204G contains a green toner. Five developing units 204C; 204Y, 204M, 204C, 204K of rotary developing unit 204 approach in turn so as to face image holding member 201, and a toner is transferred to the electrostatic latent image corresponding to each color by being rotation-driven to form a toner image.

According to a necessary image, a developing unit other than developing unit 204G in rotary developing unit 204 may be partially removed. For example, rotary developing unit 204 may be a rotary developing unit comprising four developing units of developing unit 204Y, developing unit 204M, developing unit 204C, and developing unit 204G. Further, developing units may be replaced with developing units containing developers of desire colors such as red, blue, green, etc.

First transfer roll 205, with intermediate transfer member 207 between image holding member 201, is to transfer the toner image formed on the surface of image holding member 201 to the periphery of endless belt-like intermediate transfer member 207 (first transfer). Cleaning blade 206 is to clean (remove) toner remained on the surface of image holding member 201 after transfer. Intermediate transfer member 207 is strained on the inside periphery with a plurality of support rolls 208, 209 and 210 so as to be capable of moving round in the direction of arrow D and in the reverse direction. Second transfer roll 211, with recording sheet (recording material) being conveyed in the direction of arrow E by sheet conveying unit not shown in the Fig. between support roll 210, is to transfer the toner image transferred on the periphery of intermediate transfer member 207 to the recording sheet (second transfer).

Image forming apparatus 200 is to form the toner image in order on the surface of image holding member 201 and transfer on the periphery of intermediate transfer member 207 one over the other. Image forming apparatus 200 behaves as follows. That is, in the first place, image holding member 201 is rotation-driven, and after the surface of image holding member 201 is evenly charged with charger 202 (a charging process), image holding member 201 is irradiated with light by image writing unit 203 and an electrostatic latent image is formed (a latent image-forming process). After this electrostatic latent image is developed with, for example, developer 204G for green (a developing process), the toner image is transferred to the periphery of intermediate transfer member 207 by first transfer roll 205 (a first transfer process). At this time, green toner and the like remained on the surface of image holding member 201 without being transferred to intermediate transfer member 207 is cleaned by cleaning blade 206. Intermediate transfer member 207 having been formed a green toner image on the surface of the periphery once moves round in the reverse direction and takes the position to be transferred with the next, for example, yellow toner image and laminated on the green toner image.

On and after this, with each toner of yellow, magenta, cyan and black, charging by charger 202, light irradiation by image writing unit 203, formation of toner images by developing units 204Y, 204M, 204C and 204K, and transfer of toner image on the periphery of intermediate transfer member 207 are similarly repeated in order.

In the exemplary embodiment, when a green image is formed, on the green toner image formed on the exemplary embodiment through developing process and first transfer process, the yellow toner image formed on image holding member 201 by developing unit 204Y Is transferred in the same manner as arranged in the first transfer process, and then cyan toner image formed on image holding member 201 by developing unit 204C is transferred on the yellow toner image in the same manner as arranged in the first transfer process.

When transfer of the toner images of three colors on the periphery of intermediate transfer member 207 is finished, the toner images are transferred to the recording sheet at a time by second transfer roll 211 (a second transfer process). By these processes, a recorded image comprising lamination of a cyan toner image, a yellow toner image, and a green toner image in order from the image forming surface is obtained on the image forming surface of the recording sheet. After the toner images have been transferred on the surface of the recording layer by second transfer roll 211, the transferred toner images are fixed by a fixing unit by heat fixation (a fixing process).

For example, by forming an image in this manner with a light-colored green toner so as to be formed on the side of intermediate transfer member 207 at the time of the first transfer, even if a part of the green toner remains on intermediate transfer member 207 by transfer failure at the time of the second transfer, a change in the ratio of the yellow toner and the cyan toner is controlled. Further, at fixing time, even if a part of the cyan toner in the lower layer penetrates into the fibers of the recording sheet and the hue of the image is yellowed, the hue is compensated for by laminating the green toner approaching cyan in hue.

By the fact that a crystalline resin is contained in a toner as a binder resin, in particular a crystalline resin is contained at least in a cyan toner as a binder resin, as has been described above, a change in hue is farther improved. As compared with the case where the binder resin of the toner is constituted with an amorphous resin alone, in particular as compared with the case where the binder resin of the cyan toner approaching cyan in hue positioned on the side of the recording sheet in green image is constituted with an amorphous resin alone, the toner is difficult to melt and penetration into the recording sheet is controlled, as a result a change in hue is restrained.

Charging unit, image holding unit, latent image forming unit developing unit, transfer unit, intermediate transfer member, cleaning unit, fixing unit and transfer-receiving material in image forming apparatus 200 in the drawing are explained below.

### (Charging Unit)

As charger 202 of a charging unit, for example, a charger such as Corotron is used, but a conductive or semiconductive charge roll may be used. A contact type charger using a conductive or semiconductive charge roll may apply direct current to image holding member 201 or alternating current may be superimposed. For example, by using such a charger 202, the surface of image holding member 201 is charged by generating discharge in the minute space in the vicinity of the contact area with image holding member 201. In general, charging is −300V or more and −1,000V or less. The conductive or semiconductive charge roll may be either a mono-layer structure or may be a multilayer structure. A mechanism of cleaning the surface of a charge roll may be provided.

### (Image Holding Member)

Image holding member 201 at least has a function of being formed with a latent image (an electrostatic latent image). As the image holding member, an electrophotographic photoreceptor is preferably exemplified. Image holding member 201 has a film containing an organic photoreceptor on the periphery of a cylindrical conductive substrate. The film comprises a substrate having thereon, if necessary an undercoat layer, a charge generating layer containing a charge generating material, a charge transporting layer containing a charge transporting material, and a photosensitive layer in this order. The order of a charge generating layer and the charge transporting layer may be reverse. This is a lamination type photoreceptor comprising different layers containing a charge generating material and a charge transporting material respectively (a charge generating layer, a charge transporting layer), but it may be a monolayer type photoreceptor containing a charge generating material and a charge transporting material in one and the same layer, but a lamination type photoreceptor is preferred. An intermediate layer may be provided between the undercoat layer and the photosensitive layer. Further, not only an organic photoreceptor but other kind of photosensitive layer such as an amorphous silicon photosensitive film may be used.

### (Latent Image-Forming Unit)

Image writing unit 203 of a latent image-forming unit is not especially restricted and, for example, optical equipments capable of imagewise exposing the surface of an image holding member with light sources such as semiconductor laser rays, LED rays, liquid crystal shutter light, etc., are exemplified,

### (Developing Unit)

A developing unit has a function of forming a toner image by developing a latent image formed on an image holding member with a developer containing a toner. Such developing units are not especially restricted so long as they have the above function, and they may be selected according to the purpose. For example, a known developing machine having a function of capable of adhering an electrostatic image developing toner to image holding member 201 with a brush, roller, etc., is exemplified. DC voltage is generally used to image holding member 201 but AC voltage may further be applied by superposition.

### (Transfer Unit)

As a transfer unit, a unit of applying charge of reverse polarity to the toner from the rear side of a transfer-receiving material to the transfer-receiving material and transferring a toner image to the transfer-receiving material by electrostatic force, or a transfer roll or a transfer roll presser using a conductive or semiconductive roll capable of transferring by directly contacting the surface of a transfer-receiving material via the transfer-receiving material may be used. As transfer current to be given to the image holding member, DC current may be applied or AC current may be applied by superposition. The transfer roll may be arbitrarily set according to the width of image area to be charged, the shape of the transfer charger, the width of opening, a processing speed (circumferential speed), etc. Further, for the purpose of cost saving, a monolayer foamed roll is preferably used as a transfer roll.

### (Intermediate Transfer Member)

It is sufficient to use known intermediate transfer member as the transfer member. As the materials for use in intermediate transfer member, polycarbonate resin (PC), polyvinylidene fluoride (PVDF), polyalkylene phthalate, blend material of PC/polyalkylene terephthalate (PAT), blend materials of ethylenetetrafluoroethylene copolymer (ETFE)/PC, ETFE/PAT, PC/PAT are exemplified. From the point of mechanical strength, intermediate transfer belt using thermosetting polyimide resin is preferred.

### (Cleaning Unit)

Cleaning units are not restricted and any unit can be arbitrarily selected so long as it can remove residual toner on the image holding member and, for example, units using a blade cleaning system, a brush cleaning system, of a roll cleaning system can be exemplified. As the materials of the cleaning blade, urethane rubber, Neoprene rubber, and silicone rubber are exemplified, Elastic polyurethane is preferably used for its excellent abrasion resistance. However, when toners having high transfer efficiency are used, a cleaning unit may not be used according to embodiments.

### (Fixing Unit)

A fixing unit (an image fixing apparatus) is to fix a toner image transferred to a recording member by heating or heat expressing, and equipped with a fixing member.

The green toner and toner set according to the exemplary embodiment exhibit high effect when heating amount per unit time is large, a transfer time is short, and in a high speed machine of conveying speed of sheet is 220 mm/sec or more and 600 mm/sec or less.

### (Transfer-Receiving Member)

As recording material (recording sheet) for transfer a toner image, plain paper for use in electrophotographic copier, a printer, and OHP sheet are exemplified. For further improving the smoothness of image surface after fixation, the surface of recording member is also as smooth as possible. For example, coated paper obtained by coating the surface of plain paper with a resin, etc., and art paper for printing are preferably used.

In according to the exemplary embodiment, as plain paper, e.g., those having smoothness measured according to JIS-P-8119 of 15 sec or more and 80 sec or less, and weighing 80 g/m² or less measured-according to JIS-P-8124 are exemplified. As coated paper, those having a coating layer at least on one side of paper substrate, and smoothness in the range of of 150 sec or more and 1,000 sec or less are exemplified.

As an image-forming apparatus, an image-forming apparatus generally called a tandem system having a combined image-forming apparatus equipped with developing units respectively containing developers containing a green toner, a yellow toner, a magenta toner, a cyan toner, and a black toner, and recording in sequence on image output media by superposition may be used.

### EXAMPLE

The invention will be described more specifically with reference to examples and comparative examples, but the invention is by no means restricted to the examples.

### <Preparation of Amorphous Resin (Strene/Acryl Resin) Particle Dispersion (L1)>

### (Oil Phase 1)

| | |
|---|---|
| Styrene (manufactured by Wako | 15.3 mass parts |
| Pure Chemical Industries) | |
| n-Butyl acrylate (manufactured by | 4.6 mass parts |
| Wako Pure Chemical Industries) | |
| β-Carboxyethyl acrylate | 0.6 mass parts |
| (manufactured by Rhodia Nikka) | |
| Dodecanethiol (manufactured by | 0.2 mass parts |
| Wako Pure Chemical Industries) | |

### (Oil Phase 2)

| | |
|---|---|
| Styrene (manufactured by Wako | 15.3 mass parts |
| Pure Chemical Industries) | |
| n-Butyl acrylata (manufactured by | 4.6 mass parts |
| Wako Pure Chemical Industries) | |
| β-Carboxyethyl acrylate | 0.6 mass parts |
| (manufactured by Rhodia Nikka) | |
| Dodecanethiol (manufactured by | 0.4 mass parts |
| Wako Pure Chemical Industries) | |

### (Aqueous Phase 1)

| | |
|---|---|
| Ion exchange water | 17.5 mass parts |
| Anionic surfactant | 0.35 mass parts |
| (manufactured by Rhodia Nikka) | |

### (Aqueous Phase 2)

| | | |
|---|---|---|
| Ion exchange water | 40 | mass parts |
| Anionic surfactant | 0.05 | mass parts |
| (manufactured by Rhodia Nikka) | | |
| Ammonium persulfate (manufactured | 0.3 | mass parts |
| by Wako Pure Chemical Industries) | | |

Monomer emulsified dispersion 1 is prepared by putting the components of above oil phase 1 and half of the components of aqueous phase 1 into a flask, and mixed by stirring. Similarly, the components of oil phase 2 and remaining half of aqueous phase 1 are stirred and mixed to obtain monomer emulsified dispersion 2. The components of aqueous phase 2 are put in a reactor, the inside of the reactor is thoroughly replaced with nitrogen, and heated in an oil bath with stirring until the temperature of the reaction system reaches 75° C. Monomer emulsified dispersion 1 is dripped into the reactor in the first place over 2, hours, and then monomer emulsified dispersion 2 is dripped over 1 hour to perform emulsification polymerization. After termination of dripping, polymerization is further continued at 75° C., and polymerization is finished 3 hours after. The number average particle size D50n of the obtained resin particle dispersion measured with a laser diffraction scattering system particle size distribution measuring instrument (LA-700, manufactured by Horiba, Ltd.) is 290 nm, the glass transition temperature measured at temperature ascending temperature of 10° C./min with a differential scanning calorimetry (DSC, manufactured by Shimadzu Corporation) is 52° C., the number average molecular weight (polystyrene equivalent) with gel permeation chromatography, THF as the solvent (HLC-8020, manufactured by TOSOH CORPORATION) is 12,000, and the weight average molecular weight is 32,000. After that, the solid content in the dispersion is adjusted to 40 wt % with ion exchange water. The solid content is computed as follows: 3 g of the dispersion is weighed, heated at 130° C. for 30 minutes to evaporate the water content, and computed from the weight of the dried residue.

### <Preparation of Release Agent Dispersion (W1)>

| | | |
|---|---|---|
| Wax (trade name: FNP0090, melting | 270 | mass parts |
| temperature Tw 90.2° C., manufactured | | |
| by Nippon Seiro Co., Ltd.) | | |
| Anionic surfactant (Neogen RK, | 13.5 | mass parts |
| effective component amount: 60 wt %, | | |
| as effective component: 3.0 wt % to | | |
| release agent, manufactured by Tai-ichi | | |
| Kogyo Seiyaku Co., Ltd.) | | |
| Ion exchange water | 21.6 | mass parts |

The above components are mixed, the release agent is dissolved with a pressure-ejecting type disperser (a MANTON GAULIN HOMOGENIZER, manufactured by Manton Gaulin) at liquid temperature of 120° C., and then treated by dispersion pressure of 5 MPa for 120 minutes, subsequently by 40 MPa for 360 minutes, and then cooled to obtain a release agent dispersion. The volume average particle size D50v of the particles in the dispersion is 225 nm. After that, ion exchange water is added and the concentration of solid content is adjusted to 20.0 wt % to obtain release agent dispersion (W1).

### <Preparation of Coloring Agent Dispersion (G1)>

| | |
|---|---|
| Green pigment (Heliogen Green 605DD | 200 mass parts |
| (C.I. Pigment Green 7), manufactured by | |
| BASF Japan Limited) | |
| Anionic surfactant (Neogen SC, | 33 mass parts |
| effective component 60 wt %, 10 wt % to | |
| the coloring agent, manufactured by | |
| Dai-ichi Kogyo Seiyaku Co., Ltd.) | |
| Ion exchange water | 750 mass parts |

Ion exchange water 280 mass parts and 20 mass parts of anionic surfactant are put in a stainless steel container, which container has a capacity such that the height of the liquid level is ⅓ or so of the height of the container when all the components shown above are put in, after the surfactant is thoroughly dissolved, all the green pigment is put in, the content is sufficiently stirred until the pigment is completely wet, and the system is thoroughly defoamed. After defoaming, the remaining ion exchange is added, dispersed with a homogenizer (ULTRA-TURRAX T50, manufactured by IKA) at 5,000 rpm for 10 minutes, and then stirred with a stirrer for whole day and night for defoaming. After defoaming, the dispersion is again dispersed with a homogenizer at 6,000 rpm for 10 minutes, and then stirred with a stirrer for whole day and night for defoaming. Subsequently, the dispersion is dispersed with a high pressure impact type disperser Altimizer (HJP30006, manufactured by Sugino Machine Limited) by pressure of 240 MPa. Dispersion is performed 25 pulse equivalent from the charged amount of the materials and the processing performance of the apparatus. The obtained dispersion is allowed to stand for 72 hours and precipitates are removed. The solid content concentration is adjusted to 15 weight % by adding ion exchange water. The volume average particle size D50v of the particles in the dispersion is 165 nm. D50 of the volume average particle size is the average of the measurement of 5 times with micro-track, excluding the maximum value and the minimum value, i.e., the average of three times.

### <Preparation of Coloring Agent Dispersion (G2)>

Coloring agent dispersion (G2) is obtained in the same manner as in the preparation of coloring agent dispersion (G1), except for changing the green pigment to C.I. Pigment Green 36 (Heliogen Green D9360, manufactured by ASF Japan). The volume average particle size D50v of the particles in the dispersion is 182 nm.

### <Preparation of Coloring Agent Dispersion (G3)>

Coloring agent dispersion (G3) is obtained in the same manner as in the preparation of coloring agent dispersion (G1), except for changing the green pigment to C.I. Pigment Green 7 (Cyanine Green 2GN, manufactured by Dainichiseika Color & Chemicals Mgf. Co., Ltd.). The volume average particle size D50v of the particles in the dispersion is 175 nm.

### <Preparation of Coloring Agent Dispersion (G4)>

Coloring agent dispersion (G4) is obtained in the same manner as in the preparation of coloring agent dispersion (G1), except for changing the green pigment to C.I. Pigment Green 36 (Cyanine Green 5370, manufactured by Dainichiseika Color & Chemicals Mgf. Co., Ltd.). The volume average particle size D50v of the particles in the dispersion is 166 nm.

### <Preparation of Coloring Agent Dispersion (C1)>

Coloring agent dispersion (C1) is obtained in the same manner as in the preparation of coloring agent dispersion (G1), except for changing the green pigment to cyan pigment ECB-301 (C.I. Pigment Blue 15:3, manufactured by Duinichiseika Color & Chemicals Mgf. Co., Ltd.). The volume average particle size D50v of the particles in the dispersion is 115 nm.

### <Preparation of Coloring Agent Dispersion (Y1)>

Coloring agent dispersion (Y1) is obtained in the same manner as in the preparation of coloring agent dispersion (G1), except for changing the green pigment to yellow pigment 5GX03 (C.I. Pigment Yellow 74, manufactured by Clariant Japan K.K.). The volume average particle size D50v of the particles in the dispersion is 132 nm.

### Example 1

### <Manufacture of Green Toner (TG1)>

| | |
|---|---|
| Aluminum polychloride (PAC) | 4.0 mass parts |
| (10% equivalent as Al₂O₃) | |
| A 0.1% nitric acid aqueous solution | 35.0 mass parts |

The above components are stirred and mixed to prepare a solution for preparing an aggregating agent. Subsequently:

| | |
|---|---|
| Ion exchange water | 710.0 mass parts |
| Resin particle dispersion (L1) | 430.0 mass parts |
| Rleasing agent dispersion (W1) | 125.0 mass parts |
| Coloring agent dispersion (G1) | 88.0 mass parts |

The above components are put in a round stainless steel flask having a capacity of 3 liters in order with stirring. While stirring with a homogenizer (ULTRA-TURRAX T50, manufactured by IKA) at 4,500 rpm, all the amount of the above prepared solution for preparing an aggregating agent is added thereto over 2 minutes, dispersed with a homogenizer at 7,000 rpm for 5 minutes. The flask is capped with a lid having a stirrer equipped with a magnetic seal, a thermometer and a pH meter. A mantle heater for heating is set and the dispersion is heated up to 48° C. at a temperature-ascending rate of 1° C./min, by arbitrarily adjusting the rotation number to the lowest rotation capable of stirring the dispersion at all in the flask, retained at 48° C. for 30 minutes, and the particle size of the aggregated particles is confirmed with a Coulter Couuter (TAII, manufactured by Nikkaki Bios). After that, the temperature in the flask is raised at 0.1° C./15 min, and the particle size of the aggregated particles is confirmed every 15 minutes, and temperature ascendance is stopped at the time when the volume average particle size reached 4.9 μm, and the temperature is maintained. Immediately after stopping temperature ascendance, 240 mass parts of resin particle dispersion (L1) is additionally added, retained for 30 minutes, and then a sodium hydroxide aqueous solution of 5% concentration is added, the system is heated at a temperature-ascending rate of 1° C./min, and temperature rising is stopped when the temperature reached 96° C., and retained. After that, the system is retained for 3.0 hours, and the aggregated particles are fused by heating. The system is lowered to 65° C., a sodium hydroxide aqueous solution is added to adjust pH to 9.0 and maintained for 30 minutes. After that the system is cooled and taken from the flask, sufficiently filtered with ion exchange water of 50 times the amount of the toner, washed with water, and again dispersed in ion exchange water so that the amount of the solid contents reach 10 wt %, pH is adjusted to 4.0 by adding nitric acid, stirred for 30 minutes, thoroughly filtered with ion exchange water until the electrical conductivity of the filtrate reaches 10 μS/cm or less, washed through water, and after the obtained slurry is frozen at −40° C., and then vacuum dried at 30° C. for 72 hours by a freeze drier to obtain a toner. The surface of the toner is observed with a scanning electron microscope (SEM) and cross section with transmission electron microscope (TEM). The resin, pigment and other additives are fused, and minute pores and unevenness are hardly observed. In connection with the state of dispersion of the release agent, rod-like and lump-like substances are mixed. The largest size or the maximum length is 900 nm. The particle size distribution and shape distribution are good.

A toner is prepared by mixing 100 mass parts of the obtained toner, 1.5 mass parts of hydrophobic silica (RY50, manufactured by Aerosil); and 1.0 mass part of hydrophobic titanium oxide (T805, manufactured by Aerosil) with a sample mill at 10,000 rpm for 45 seconds. The volume average particle size D50v is 5.85 μm, GSD (volume) is 1.17, GSD (number) is 1.18, 3 μm under amount is 1.25%, shape factor (FPIA) is 0.965, CV value of the shape factor is 2.24%.

### <Manufacture of Carrier>

| | | |
|---|---|---|
| Mn—Mg—Sr ferrite particles (volume | 100 | mass parts |
| average particle size: 40 μm) | | |
| Toluene | 14 | mass parts |
| Cyclohexyl methacrylate/dimethyl- | 2.0 | mass parts |
| aminoethyl methacrylate copolymer | | |
| (copolymerization ratio: 99/1, | | |
| Mw: 80,000) | | |
| Carbon black (VXC72, manufactured | 0.12 | mass parts |
| by Cabot Corporation) | | |

A resin-covered carrier is obtained by stirring the above components, exclusive of ferrite particles, and glass beads (φ: 1 mm, the same amount with toluene) with a sand mill (manufactured by Kansai Paint Co., Ltd.), 200 ppm/30 min. The solution for forming a resin-covered layer and ferrite particles are put in a vacuum deaerator kneader and pressure is reduced to remove toluene, and the obtained product is dried to obtain a resin-covered carrier.

### <Manufacture of Developer>

To 500 mass parts of the above carrier is added 40 mass parts of the above green toner (TG1) and blended with a V-type blender for 20 minutes, and then filtered through a vibration filter having a pore diameter of 212 μm to remove the aggregates and developer (DG1) is obtained. Further, 100 mass parts of green toner (TG1) is added to 20 mass parts of the above carrier, blended with the above V-type blender for 20 minutes, filtered through a vibration filter having a pore diameter of 212 μm to remove the aggregates to obtain replenishing developer (DAG1).

### <Manufacture of Cyan Toner (TC1) and Developer>

Cyan toner (TC1), developer (DC1) and replenishing developer (DAC1) are obtained in the same manner as in the preparation of green toner (TG1) except for changing 88.0 mass parts of coloring agent dispersion (G1) to 110.0 mass parts of coloring agent dispersion (C1).

### <Manufacture of Yellow Toner (TY1) and Developer>

Yellow toner (TY1) developer (DY1) and replenishing developer (DAY1) are obtained in the same manner as in the preparation of green toner (TG1) except for changing 88.0 mass parts of coloring agent dispersion (G1) to 130.0 mass parts of coloring agent dispersion (Y1).

### <Evaluation of Image>

From the main body, developing unit and toner cartridge of Docu Centre Color 500 CP (a product of Fuji Xerox Co., Ltd.), the charged developer and toners are taken out and thoroughly cleaned. The above manufactured developer is put in the developing unit, and replenishing toner is put in each toner cartridge. Cyan developing unit is set at the original position of the cyan developing unit of Docu Centre Color 500 CP, yellow developing unit is set at the original position of the magenta developing unit, and green developing unit is set at the original position of the yellow developing unit, respectively. The amount of developing toner of each mono-color 100% on OK Top Coat Paper (coated paper, degree of smoothness: 5,000 sec or more, weighing; 127 g/m², manufactured by Oji Paper Co., Ltd.) is adjusted to 4.0 g/m², and images of the second colors of yellow toner 100%, cyan toner 100%, and an image of green toner 100%, each baving a size of 5 cm×5 cm are manufactured (fixing unit: fixing unit mounted on Docu Centre Color 500 CP, sheet conveying rate: 160 mm/sec, temperature of heating roll: 180° C., temperature of pressure roll: 150° C.). The density and L*a*b* of each of the obtained images are measured. X-Rite 939 (aperture: 4 mm) is used in the measurement, in the surface of the image is randomly measured 10 times, and the average values are taken as density and brightness. Density of the second color IDcy, green image density ID are computed from a*b* value, and hue angle of the second colors Acy and hue angle of the green image A are computed. The obtained values are shown in Table 1 below.

Each amount of the developing toners of yellow toner and cyan toner 100% image on OK Top Coat Paper is adjusted to 3.5 g/m². And then, the amount of developing toner of green toner 100% image is adjusted to 1.5 g/m² so that the image densities at the time when each of three colors including the green toner image outputted by 100% are the same density as the second color images of yellow toner 100% and cyan toner 100% whose toner amounts are adusted to 4.0 g/m², and each of three colors of 100% output third color images and 50% output third color images are manufactured (fixing unit: fixing unit mounted on Docu Centre Color 500 CP, sheet conveying rate: 160 mm/sec, temperature of heating roll: 180° C., temperature of pressure roll: 150° C.), and each hue angle is measured. From the results of measurement, the difference in hue angle (AD100) is computed by subtracting the hue angle of the third color image of each 100% output manufactured on OK Top Coat Paper from the hue angle of the third color image of each 100% output manufactured on P sheet. With respect to 50% output images, the difference in hue angle (AD50) is also computed similarly. The absolute value of the difference in hue angle (ΔAD) is computed by subtracting the hue angle of the second color image (Acy) comprising each yellow toner 100% and cyan toner 100% which is adjusted in the developing toner amount of monocolor 100% image to 4.0 g/m² on the coated paper from the hue angle of the third color image of each three color comprising 100% output formed on the coated paper. The values are shown in Table 1.

### Example 2

Green toner (TG2), developer (DG2) and replenishing developer (DAG2) are manufactured in the same manner as in the manufacture of green toner (TG1) except for changing 88.0 mass parts of coloring agent dispersion (G1) to 22.0 mass parts, and evaluation is performed in the same manner as in Example 1. 1The results are shown in Table 1.

### Example 3

Green toner (TG3), developer (DG3) and replenishing developer (DAG3) are manufactured in the same manner as in the manufacture of green toner (TG1) except for changing 88.0 mass parts of coloring agent dispersion (G1) to 39.6 mass parts, and evaluation is performed in the same manner as in Example 1. The results are shown in Table 1.

### Example 4

Green toner (TG4), developer (DG4) and replenishing developer (DAG4) are manufactured in the same manner as in the manufacture of green toner (TG1) except for changing 88.0 mass parts of coloring agent dispersion (G1) to 55.0 mass parts of coloring agent dispersion (G4), and evaluation is performed in the same manner as in Example 1. The results are shown in Table 1.

### Example 5

Green toner (TG5), developer (DG5) and replenishing developer (DAG5) are manufactured in the same manner as in the manufacture of green toner (TG1) except for changing 88.0 mass parts of coloring agent dispersion (G1) to 44.0 mass parts of coloring agent dispersion (G2), and evaluation is performed in the same manner as in Example 1. The results are shown in Table 1.

### Example 6

Green toner (TG6), developer (DG6) and replenishing developer (DAG6) are manufactured in the same manner as in the manufacture of green toner (TG1) except for changing 88.0 mass parts of coloring agent dispersion (G1) to 45.0 mass parts of coloring agent dispersion (G3), and evaluation is performed in the same manner as in Example 1. The results are shown in Table 1.

### Example 7

Green toner (TG7), developer (DG7) and replenishing developer (DAG7) are manufactured in the same manner as in the manufacture of green toner (TG1) except for changing 88.0 mass parts of coloring agent dispersion (G1) to 71.0 mass parts, and evaluation is performed in the same manner as in Example 1. The results are shown in Table 1.

### Comparative Example 1

Green toner (TGH1), developer (DGH1) and replenishing developer (DAGH1) are manufactured in the same manner as in the manufacture of green toner (TG1) except for not using the green toner, and evaluation is performed in the same manner as in Example 1. The results are shown in Table 1.

### Comparative Example 2

Green toner (TGH12), developer (DGH2) and replenishing developer (DAGH2) are manufactured in the same manner as in the manufacture of green toner (TG1) except for changing 88.0 mass parts of coloring agent dispersion (G1) to 143.0 mass parts, and evaluation is performed in the same manner as in Example 1. The results are shown in Table 1.

### Comparative Example 3

Green toner (TGH3), developer (DGH3) and replenishing developer (DAGH3) are manufactured in the same manner as in the manufacture of green toner (TG1) except for changing 88.0 mass parts of coloring agent dispersion (G1) to 17.6 mass parts, and evaluation is performed in the same manner as in Example 1. The results are shown in Table 1.

### Comparative Example 4

Green toner (TGH4), developer (DGH4) and replenishing developer (DAGH4) are manufactured in the same manner as in the manufacture of green toner (TG1) except for changing 88.0 mass parts of coloring agent dispersion (G1) to the mixture of 44.0 mass parts of coloring agent dispersion (G2) and 11.0 mass parts of coloring agent dispersion (Y1), and evaluation is performed in the same manner as in Example 1. The results are shown in Table 1.

### Comparative Example 5

Green toner (TGH5), developer (DGH5) and replenishing developer (DAGH5) are manufactured in the same manner as in the manufacture of green toner (TG1) except for changing 88.0 mass parts of coloring agent dispersion (G1) to the mixture of 48.4 mass parts of coloring agent dispersion (G3) and 6.6 mass parts of coloring agent dispersion (C1), and evaluation is performed in the same manner as in Example 1. The results are shown in Table 1.

### <Results of Evaluation>

In Table 1, with respect to AD100 and AD50, the value of 1.0 or less is graded “very good”, greater than 1.0 and 2.0 or less is “good”, and greater than 2.0 is graded “bad”. With respect to ΔAD, 1.5 or less is graded “very good”, greater than 1.5 and 2.5 or less is “good”, and greater than 2.5 is graded “bad”.

The toners in Examples are small both in AD100 and AD50, and difference in hue between sheets and in the surface of sheet is improved. When the image density of the green toner is high, the developing amount of the green toner is low, therefore, the effect of the addition of the green toner is small, and the difference in hue angle of 50% image is liable to be high. Contrary to this, when the density of the green toner is too low, the developing amount of the green toner increases, therefore, the transfer efficiency deteriorates especially on plain paper, and AD100 is liable to be high When AD100 and AD50 are high, a problem that deviation in colors between sheets becomes large arises.

When the green toner small in the difference in hue angle (A−Acy) of image is used, the effect for compensating for cyan color is small, so that AD50 is liable to be great. On the other hand, when the difference in hue angle (A−Acy) of image is great, the influence of the hue of the green toner is large, so that both AD100 and AD50 are liable to be great and, at the same time, difference in hue angle (ΔAD) is liable to be great according to the presence or absence of the green toner. When ΔAD is great, the region of green deviates to the hue of the image at large and the color balance of image is lost.

On the other hand, with respect to the toner in Comparative Example 1, when the image is formed with the yellow toner and cyan toner alone, both AD100 and AD50 are high and difference occurs in hue angle. With respect to the toner in Comparative Example 2 to which a high density green toner is additionally added, although difference in hue angle ascribable to difference between sheets is improved, the density of green toner is high, accordingly, in the region where the density of image manufactured by the yellow toner and the cyan toner is low, the developing amount of the green toner is low and the effect of the addition of the green toner is small, difference in hue angle of 50% image (AD50) is high. In a real image, a change in hue of a solid image is great according to the presence or absence of the green toner.

### <Preparation of Amorphous Resin (Polyester Resin) Particle Dispersion (PA1)>

### (1) Preparation of Amorphous Polyester Resin (PA1)

| | |
|---|---|
| Ethylene oxide 2.2 mol adduct of | 10 mol % |
| bisphenol A | |
| Propylene oxide 2.2 mol adduct of | 40 mol % |
| bisphenol A | |
| Terephthalic acid | 22 mol % |
| Fumaric acid | 15 mol % |
| Dodecenylsuccinic acid anhydride | 11 mol % |
| Trimellitic acid anhydride | 2 mol % |

The above monomer components, exclusive of fumaric acid and trimellitic acid anhydride, and tin dioctanoate in an amount of 0.25 mass parts to the total 100 mass parts of the above monomer components are put in a reaction vessel equipped with a stirrer, a thermometer, a condenser, and a nitrogen gas-introducing pipe, and reacted under nitrogen current at 235° C. for 6 hours. After that, the temperature is lowered to 200° C., and the above fumaric acid and trimellitic acid anhydride are added thereto, and reaction for 1 hour. The temperature is increased to 220° C. over 4 hours, polymerization is continued under pressure of 10 kPa to reach a desired molecular weight, and a pale yellow transparent amorphous polyester resin is obtained. The glass transition temperature Tg of the amorphous polyester resin by DSC is 59° C., weight average molecular weight Mw by GPC is 23,000, number average molecular weight Mn is 7,000, softening temperature by a flow tester is 106° C., and acid value AV is 11 mg KOH/g.

### (2) Preparation of Amorphous Polyester Resin Dispersion (PA1)

Into a reaction bath (BJ-30N, manufactured by TOKYO RIKAKIKE CO., LTD.) having a capacity of 3 liters equipped with a condenser, a thermometer, a water dripping funnel, a jacket with an anchor blade maintained at 40° C. with a water-circulating constant temperature bath, a mixture comprising 160 mass parts of methyl ethyl ketone and 100 mass parts of isopropyl alcohol is poured, and further 300 mass parts of the above amorphous polyester resin is added thereto, stirred with a three-one motor at 150 rpm, and the system is dissolved to obtain an oil phase. To this oil phase being stirred, 14 mass parts of a 10 mass % aqueous ammonia solution is dripped for dripping time of 5 minutes and mixed for 10 minutes, after that, 900 mass parts of ion exchange water is further dripped thereto at a dripping rate of 7 mass parts/min for phase inversion emulsification. The obtained emulsified liquid (800 mass parts) and 500 mass parts of ion exchange water are put in an egg-plant type flask having a capacity of 2 liters, and the flask is set to an evaporator (manufactured by TOKYO RIKAKIKAI CO., LTD.) equipped with vacuum control unit via a trap ball. After heating the mixed liquid at 60° C. for 30 minutes in a hot water bath while rotating the egg-plant type flask to stabilize the liquid temperature, pressure reduction is started. As pressure reduction conditions: from 101 kPa to 60 kPa with the limit velocity of pump performance, from 50 kPa to 7 kPa, pressure is reduced for 250 minutes, after arriving 7 kPa. 7 kPa is maintained, and the degree of vacuum is arbitrarily adjusted to avoid bumping of the content in the midway, and the solvent is recovered (a solvent removing process). When the amount of the recovered solvent reached 850 mass parts, pressure is returned to atmospheric pressure, the egg-plant type flask is cooled with water and amorphous polyester resin dispersion (PA1) is obtained. The volume average particle size of the resin particles in the dispersion AD50 is 140nm. After that, the solid content concentration is adjusted with ion exchange water to 20 mass %.

### (3) Preparation of Additional Amorphous Polyester Resin Dispersion (PA1A)

Amorphous polyester resin dispersion (PA1) (350 mass parts) is put in a 500 ml beaker, and 3.4 mass parts of anionic surfactant (Dowfax 2A1, manufactured by The Dow Chemical Company) is added while stirring the mixture with a magnetic stirrer at a speed of not dragging bubbles in. After stirring for 10 minutes, pH is adjusted to 3.8 with 0.3M nitric acid. After stirring for 30 minutes, pH is again adjusted to 3.8 to prepare additional amorphous polyester resin dispersion (PA1A).

### <Manufacture of Crystalline Polyester Resin Dispersion (PC1)>

### (1) Preparation of Crystalline Polyester Resin (PC1)

| | |
|---|---|
| 1,10-Dodecane diacid | 50 mol % |
| 1,9-Nonanediol | 50 mol % |

The above monomer components are put in a reaction vessel equipped with a stirrer, a thermometer, a condenser, and a nitrogen gas-introducing pipe. After the inside of the reaction vessel is substituted with dry nitrogen gas, titanium tetrabutoxide (a reagent) in an amount of 0.25 mass parts to 100 mass parts of the above monomer components is added to the vessel and reacted under nitrogen current at 170° C. for 3 hours. The temperature is raised to 210° C., the inside of the vessel is reduced to 3 kPa, and stirring is continued for 13 hours under reduced pressure to obtain crystalline polyester resin (C1). The melting temperature Tc of the amorphous polyester resin (C1) by DSC. is 73.6° C., weight average molecular weight Mw by GPC is 25,000, number average molecular weight Mn is 10,500, and acid value AV is 10.1 mg KOH/g.

### (2) Manufacture of Crystalline Polyester Resin Dispersion (PC1)

Into a separable flask having a capacity of 2 liters equipped with a stirrer, a condenser, a thermometer, and a water dripping funnel, 300 mass parts of crystalline polyester resin (PC1), 105 mass parts of methyl ethyl ketone (a solvent), and 90 mass parts of isopropyl alcohol (solvent) are added. The reaction mixture is heated in a hot water bath at 70° C., and the resin is dissolved by stirring and mixing at 100 rpm while maintaining 70° C. (a dissolved liquid preparation step). After that, rotation number is raised to 150 rpm, hot water bath is set at 66° C., the system is allowed to stand for 30 minutes and the temperature is stabilized. Subsequently, 15 mass parts of 10 mass % aqueous ammonia (a reagent) is put thereto over 1 minute, mixed for 10 minutes, and ion exchange water maintained at 66° C. is dripped it total of 900 mass parts at a rate of 7 mass parts/min for phase inversion emulsification, and an emulsified liquid is obtained. Immediately after stopping water dripping, the obtained emulsified liquid is cooled to 25° C. with a water bath of 20° C. The emulsified liquid after cooling (800 mass parts) and 500 mass parts of ion exchange water are put in an egg-plant type flask having a capacity of 2 liters, and the flask is set to an evaporator (manufactured by TOKYO RIKAKIKAI CO., LTD.) equipped with vacuum control unit via a trap ball. After heating the mixed liquid at 60° C. for 30 minutes in a hot water bath while rotating the egg-plant type flask to stabilize the liquid temperature, pressure reduction is started. As pressure reduction conditions: from 101 kPa to 50 kPa with the limit velocity of pump performance, from 50 kPa to 7 kPa, pressure is reduced for 172 minutes, after arriving 7 kPa, 7 kPa is maintained, and the degree of vacuum is arbitrarily adjusted to avoid bumping of the content in the midway, and the solvent is recovered. When the amount of the recovered solvent reached 850 mass parts, pressure is returned to atmospheric pressure, the egg-plant type flask is cooled with water and amorphous polyester resin dispersion (PC1) is obtained. The solid content concentration is adjusted with ion exchange water to 30 mass %.

### Example 8

| | |
|---|---|
| Aluminum sulfate powder | 35 mass parts |
| (17% aluminum sulfate, manufactured | |
| by Asada Chemical Industry Co., Ltd.) | |
| Ion exchange water | 1,965 mass parts |

The above components are put into a vessel having a capacity of 2 liters, and stirred and mixed until the precipitates disappear at 30° C., thus an aqueous aluminum sulfate solution is prepared.

| | | |
|---|---|---|
| Crystalline polyester resin | 58 | mass parts |
| dispersion (PC1) | | |
| Amorphous polyester resin | 650 | mass parts |
| dispersion (PA1) | | |
| Coloring agent dispersion (C1) | 91.5 | mass parts |
| Release agent dispersion (W1) | 103.0 | mass parts |
| Ion exchange water | 200 | mass parts |
| Anionic surfactant (Dowfax 2A1, | 7.0 | mass parts |
| manufactured by The Dow Chemical Company) | | |

The above components are put in a reaction vessel having a capacity of 3 liters equipped with a thermometer, a pH meter and a stirrer, while dispersing with a homogenizer (ULTRA-TURRAX T50, manufactured by IKA) at 5,000 rpm, 25° C., 125 mass parts of the prepared aluminum sulfate aqueous solution is added and dispersed for 6 minutes. After that, a stirrer and a mantle heater are fit up to the reaction vessel, temperature is raised at a rate of 0.2° C./min until temperature reaches 40° C., and after the temperature exceeded 40° C., a rate of 0.05° C./min, and the rotary number of the stirrer is adjusted so that the slurry is sufficiently stirred. The particle size is measured every 10 minutes with Multisizer II (manufactured by Beckmann Coulter, Inc.) with an aperture of 50 μm, and when the volume average particle size reaches 5.0 μm the temperature is retained, and additional amorphous polyester resin dispersion (A1A) is added over 5 minutes and retained for 30 minutes after the addition. After the dispersion is retained for 30 minutes, pH is adjusted to 9.0 with 4 mass % of sodium oxide aqueous solution, and after that, pH is adjusted to 9.0 every 5° C. Temperature is raised to 90° C. at a rate of 1° C./min and retained at 90° C. The particle shape and surface property of the particles are observed with an optical microscope and scanning electron microscope (FE-SEM) every 15 minutes. Since the coalescence of particles are observed after 1 hour, the vessel is cooled with cooling water and cooled to 30° C. in 5 minutes.

The slurry after cooling is filtered through a nylon mesh with a pore size of 15 μm, and after removing crude powders, slurry passed through the filter is filtered with an aspirator under reduced pressure. The toner remained on the filter paper is crushed as fine as possible and thrown into ion exchange water of 10 times the toner at 30° C., stirred and mixed for 30 minutes, filtered through aspirator again under reduced pressure, and the electrical conductivity of the filter is measured. This operation is repeated until the electrical conductivity of the filter reaches 10 μS/cm or lower and the toner is washed. Washed toner is finely crushed with a wet-dry sizer (Comil), and dried by vacuum drying in an oven at 35° C. for 36 hours to obtain toner particles. To 100 mass parts of the obtained toner particles, 1.0 mass parts of hydrophobic silica (RY50, manufactured by Aerosil), and 0.8 parts of hydrophobic titanium oxide (T805, manufactured by Aerosil) are added, and they are blended at 13,000 rpm for 30 seconds. After that, the toner is filtered-through a vibration filter having a pore diameter of 45 μm to obtain toner (TC2).

The volume average particle size of the obtained toner is D50v 6.0 μm, shape factor is 0.960 (FPIA-3000, manufactured by Sysmex Co.). From the SEM image of the toner, smooth surfaces are confirmed, and protrusions of the release agent and peeling of the surface layers are not observed.

| | | |
|---|---|---|
| Mn—Mg—Sr ferrite particles | 100 | mass parts |
| (volume average particle size: 40 μm) | | |
| Toluene | 14 | mass parts |
| Cyclohexyl methacrylate/dimethyl- | 2.0 | mass parts |
| aminoethyl methacrylate copolymer | | |
| (copolymerization, ratio: 99/1, | | |
| Mw: 80,000) | | |
| Carbon black (VXC72, manufactured | 0.12 | mass parts |
| by Cabot Corporation) | | |

The above components, excluding ferrite particles, and glass beads (φ1 mm, the same amount as toluene) are stirred with a sand mill (manufactured by Kansai Paint Co., Ltd.), 1,200 ppm/30 min to prepare a resin coating layer forming solution. Further, this resin coating layer forming solution and ferrite particles are put in a vacuum deaerator type kneader and pressure is reduced to remove toluene, and the obtained product is dried to obtain a resin-covered carrier.

The above toner 40 mass parts is added to 500 mass parts of the carrier and blended with a V-type blender for 20 minutes, and then filtered through a vibration filter having a pore diameter of 212 μm to remove the aggregates and developer (DC2) is obtained.

Further, 100 mass parts of toner is added to 20 mass parts of the above carrier, blended with the above V-type blender for 20 minutes, filtered through a vibration filter having a pore diameter of 212 μm to remove the aggregates to obtain replenishing developer (DC2A). Evaluations are performed in the same manner except for replacing the cyan toner and developer in Example 3 with the cyan toner and developer in Example 8.

TABLE 1

| | Example No. | | | | | | | |
|---|---|---|---|---|---|---|---|---|
| | | | | | | | | Example 8 |
| | | | | | | | | Containing |
| | | | | | | | | crystalline |
| | Example 1 | Example 2 | Example 3 | Example 4 | Example 5 | Example 6 | Example 7 | resin |
| Kind of Y pigment | Y74 | Y74 | Y74 | Y74 | Y74 | Y74 | Y74 | Y74 |
| Kind of C pigment | PB 15:3 | PB 15:3 | PB 15:3 | PB 15:3 | PB 15:3 | PB 15:3 | PB 15:3 | PB 15:3 |
| IDcy | 1.8 | 1.8 | 1.8 | 1.8 | 1.8 | 1.8 | 1.8 | 1.8 |
| Hue angle Acy (degree) | 157 | 157 | 157 | 157 | 157 | 157 | 157 | 158 |
| Kind of light-colored G | PG7 | PG7 | PG7 | PG36 | PG36 | PG7 | PG7 | PG7 |
| pigment | | | | | | | | |
| ID | 1.2 | 0.3 | 0.5 | 0.5 | 0.4 | 0.5 | 0.9 | 0.5 |
| Hue angle A (degree) | 178 | 182 | 181 | 170 | 162 | 188 | 179 | 181 |
| ID/IDcy | 0.67 | 0.17 | 0.28 | 0.28 | 0.22 | 0.28 | 0.50 | 0.28 |
| A-Acy | 21 | 25 | 24 | 13 | 5 | 31 | 22 | 23 |
| AD100 | 1.0 | 1.7 | 0.8 | 1.0 | 1.0 | 0.8 | 0.9 | 0.8 |
| AD50 | 1.9 | 1.6 | 0.6 | 1.0 | 1.7 | 0.8 | 1.6 | 0.4 |
| ΔAD | 2.2 | 0.6 | 1.0 | 0.9 | 0.4 | 1.7 | 1.5 | 0.9 |

| | Example No. | | | | |
|---|---|---|---|---|---|
| | Comparative | Comparative | Comparative | Comparative | Comparative |
| | Example 1 | Example 2 | Example 3 | Example 4 | Example 5 |
| Kind of Y pigment | Y74 | Y74 | Y74 | Y74 | Y74 |
| Kind of C pigment | PB 15:3 | PB 15:3 | PB 15:3 | PB 15:3 | PB 15:3 |
| IDcy | 1.8 | 1.8 | 1.8 | 1.8 | 1.8 |
| Hue angle Acy (degree) | 157 | 157 | 157 | 157 | 157 |
| Kind of light-colored G | None | PG7 | PG7 | PG36 + | PG7 + |
| pigment | | | | PY74 | PB 15:3 |
| ID | — | 1.6 | 0.2 | 0.6 | 0.6 |
| Hue angle A (degree) | — | 178 | 182 | 160 | 194 |
| ID/IDcy | — | 0.89 | 0.11 | 0.31 | 0.33 |
| A-Acy | — | 21 | 25 | 3 | 37 |
| AD100 | 2.5 | 1.1 | 2.1 | 1.3 | 1.4 |
| AD50 | 3.3 | 2.6 | 1.8 | 2.3 | 1.5 |
| ΔAD | 0.0 | 3.1 | 1.2 | 0.3 | 2.6 |

By using crystalline resin, the control of a change in hue is further improved in Example 3.

The foregoing description of the exemplary embodiments of the present invention has been provided for the purpose of illustration and description. It is not intended to be exhaustive or to limit the invention to the precise forms disclosed. Obviously, many modifications and variations will be apparent to practitioners skilled in the art. The exemplary embodiments are chosen and described in order to best explain the principles of the invention and its practical applications, thereby enabling others skilled in the art to understand the invention for various exemplary embodiments and with the various modifications as are suited to the particular use contemplated. It is intended that the scope of the invention be defined by the following claims and their equivalents.

What is claimed is:

1. An electrostatic image developing green toner, comprising;
a binder resin;
a coloring agent; and
a release agent, and
the electrostatic image developing green toner satisfying the following equations:
0.3<ID<1.2
160°<A<190°
wherein ID represents an image density at a time when a first image is formed by a loading amount of 4.0 g/m² of the green toner on a recording member; and
A represents a hue angle of the first image represented by an L*a*b* color coordinate space, provided that an upside of a*+axis is taken as hue angle 0° and an upside of b*+axis is taken as hue angle 90°.

2. The electrostatic image developing green toner according to claim 1, which satisfies the following equations:
0.1<(ID/IDcy)<0.7
Acy<A
wherein IDcy represents an image density at a time when a second image is formed by a loading amount of 4.0 g/m² of a cyan toner and a loading amount of 4.0 g/m² of a yellow toner on a recording member used together in an image-forming apparatus; and
Acy represents a hue angle of the second image represented by the L*a*b* color coordinate space.

3. The electrostatic image developing green toner according to claim 2, wherein A and Acy satisfy the following equation:
5°<(A−Acy)<35°.

4. The electrostatic image developing green toner according to claim 1, wherein the binder resin contains a crystalline resin.

5. The electrostatic image developing green toner according to claim 4,
wherein a content of the crystalline resin in the binder resin is about 2 wt % or more and about 20 wt % or less.

6. The electrostatic image developing green toner according to claim 4,
wherein the crystalline resin is a crystalline polyester resin.

7. The electrostatic image developing green toner according to claim 6,
wherein the crystalline polyester resin has a melting temperature of about 50° C. or higher and about 120° C. or lower.

8. The electrostatic image developing green toner according to claim 6,
wherein the crystalline polyester resin has a weight average molecular weight (Mw) of about 5,000 or more and about 100,000 or less.

9. The electrostatic image developing green toner according to claim 6,
wherein the crystalline polyester resin has an acid value of about 4 mg KOH/g or more and about 20 mg KOH/g or less.

10. The electrostatic image developing green toner according to claim 1,
wherein a content of the coloring agent in the green toner is about 0.5 wt % or more and about 8 wt % or less.

11. The electrostatic image developing green toner according to claim 1,
wherein the coloring agent has a dispersion particle size of about 30 nm or more and about 300 nm or less.

12. The electrostatic image developing green toner according to claim 1,
wherein the release agent has a subjective maximum endothermic peak measured with a DSC in conformity with ASTM D3418-8 of about 60° C. or more and about 120° C. or less, and a melting viscosity of about 1 mPas or more and about 50 mPas or less at 140° C.

13. The electrostatic image developing green toner according to claim 1,
wherein an addition amount of the release agent is about 1 mass part or more and about 15 mass parts or less per 100 mass parts of the binder resin.

14. The electrostatic image developing green toner according to claim 1, which has a volume average particle size of about 4 μm or more and about 9 μm or less.

15. The electrostatic image developing green toner according to claim 1, which has a shape factor SF1 of about 110 or more and about 145 or less.

16. An electrostatic image developer, comprising:
the electrostatic image developing green toner according to claim 1; and
a carrier.

17. The electrostatic image developer according to claim 16,
wherein the carrier has a volume electric resistance value of about 10⁹ Ωcm or more and about 10¹⁴ Ωcm or less.

18. An electrostatic image developing toner set, comprising:
a cyan toner;
a yellow toner; and
a green toner, each containing a binder resin, a coloring agent and a release agent, and
the electrostatic image developing toner set satisfying the following equations:
0.3<ID<1.2
160°<A<190°
0.1<(ID/IDcy)<0.7
Acy<A
wherein ID represents an image density at a time when a first image is formed by a loading amount of 4.0 g/m² of the green toner on a recording member;
A represents a hue angle of the fast image represented by an L*a*b* color coordinate space, provided that an upside of a*+axis taken as hue angle 0° and an upside of b*+axis is taken as hue angle 90°;
IDcy represents an image density at a time when a second image is formed by a loading amount of 4.0 g/m² of the cyan toner and a loading amount of 4.0 g/m² of the yellow toner on a recording member; and
Acy represents a hue angle of the second image represented by the L*a*b* color coordinate space.

19. An electrostatic image developer set, comprising:
a cyan developer;
a yellow developer, and
a green developer, respectively containing a cyan toner, a yellow toner and a green toner, and a carrier, each of the cyan, yellow and green toners containing a binder resin, a coloring agent and a release agent, and
the electrostatic image developer set satisfying the following equations:
0.3<ID<1.2
160°<A<190°
0.1<(ID/IDcy)<0.7
Acy<A
wherein ID represents an image density at a time when a first image is formed by a loading amount of 4.0 g/m² of the green toner on a recording member,
A represents a hue angle of the first image represented by a L*a*b* color coordinate space, provided that an upside of a*+axis is taken as hue angle 0° and an upside of b*+axis is taken as hue angle 90°;
IDcy represents an image density at a time when a second image is formed by a loading amount of 4.0 g/m² of the cyan toner and a loading amount of 4.0 g/m² of the yellow toner on a recording member; and
Acy represents a hue angle of the second image represented by the L*a*b* color coordinate space.

20. An image-forming apparatus, comprising:
an image holding member;
a latent image forming unit that forms an electrostatic latent image on a surface of the image holding member;
a developing unit that forms a toner image by developing the electrostatic latent image with an electrostatic image developer containing an electrostatic image developing toner;
a first transfer unit that transfers the developed toner image to an intermediate transfer member; and
a second transfer unit that transfers the toner image transferred to the intermediate transfer member to a recording member,
wherein the toner contains:
a cyan toner,
a yellow toner; and
a green toner, each containing a binder resin, a coloring agent and a release agent, and
the toner satisfying the following equations:
0.3<ID<1.2
160°<A<190°
0.1<(ID/IDcy)<0.7
Acy<A
wherein ID represents an image density at a time when a first image is formed by a loading amount of 4.0 g/m² of the green toner on a recording member,
A represents a hue angle of the first image represented by a L*a*b* color coordinate space, provided that an upside of a*+axis is taken as hue angle 0° and an upside of b*+axis is taken as hue angle 90°;
IDcy represents an image density at a time when a second image is formed by a loading amount of 4.0 g/m² of the cyan toner and a loading amount of 4.0 g/m² of the yellow toner on a recording member; and
Acy represents a hue angle of the second image represented by the L*a*b* color coordinate space.
